(19) United States
(12) Patent Application Publication
(10) Pub. No.: US 2019/0044689 A1
(43) Pub. Date: Feb. 7, 2019

(54) BANDWIDTH PART SIGNALING AND MEASUREMENT HANDLING

(71) Applicant: Intel IP Corporation, Santa Clara, CA (US)

(72) Inventors: Candy Yiu, Portland, OR (US); Youn Hyoung Heo, Seoul (KR); Jeongho Jeon, San Jose, CA (US); Jie Cui, Santa Clara, CA (US); Richard Burbidge, Shrivenham (GB); Yujian Zhang, Beijing (CN); Yang Tang, San Jose, CA (US)

(21) Appl. No.: 16/146,009

(22) Filed: Sep. 28, 2018

Related U.S. Application Data
(60) Provisional application No. 62/564,787, filed on Sep. 28, 2017.

(51) Int. Cl. H04L 5/00; H04W 72/04; H04W 24/10

(52) U.S. Cl. CPC H04L 5/0098; H04W 24/10; H04W 72/0453; H04W 72/042

(57) ABSTRACT

An apparatus is configured to be employed within a base station. The apparatus comprises baseband circuitry and/or application circuitry which includes a radio frequency (RF) interface and one or more processors. The one or more processors are configured to generate a bandwidth part (BWP) configuration for a user equipment (UE) device, where the BWP configuration includes an initial BWP for the UE device; and provide the BWP configuration to the UE device using the RF interface.

### REFERENCE TO RELATED APPLICATIONS

This application claims the benefit of U.S. Provisional Application No. 62/564,787, filed Sep. 28, 2017, the contents of which are herein incorporated by reference in their entirety.

### FIELD

Various embodiments generally relate to the field of wireless communications.

### BACKGROUND

Wireless or mobile communication involves wireless communication between two or more devices. The communication requires resources to transmit data from one device to another and/or to receive data at one device from another.

One of the resources used for communication is bandwidth. The bandwidth includes frequencies or ranges of frequencies used. Further, bandwidth is a limited resource and is typically in high demand.

The allocation and use of bandwidth can be problematic. Insufficient bandwidth can degrade communications, such as by slowing data transfer. However, unused or underused bandwidth means that resources could be better used.

What are needed are techniques to facilitate the allocation and use of bandwidth for wireless communication systems.

### BRIEF DESCRIPTION OF THE DRAWINGS

FIG. 1 illustrates a block diagram of an example wireless communications network environment for a network device (e.g., a UE, gNB or an eNB) according to various aspects or embodiments.

FIG. 2 illustrates another block diagram of an example of wireless communications network environment for a network device (e.g., a UE, gNB or an eNB) according to various aspects or embodiments.

FIG. 3 another block diagram of an example of wireless communications network environment for network device (e.g., a UE, gNB or an eNB) with various interfaces according to various aspects or embodiments.

FIG. 4A is a diagram illustrating an architecture of a system that facilitates use of bandwidth parts (BWPs) and measurement in accordance with some embodiments.

FIG. 4B is a diagram illustrating an architecture of a system that facilitates use of bandwidth parts (BWPs) and measurement in accordance with some embodiments.

FIG. 5 is a diagram illustrating types of BWPs in accordance with some embodiments.

FIG. 6 is a table depicting measurement configurations for BWPs and cells in accordance with some embodiments.

FIG. 7 is a diagram illustrating an example BWP configuration in accordance with some embodiments.

FIG. 8 is a diagram illustrating an example BWP configuration for a set of BWPs in accordance with some embodiments.

### DETAILED DESCRIPTION

The present disclosure will now be described with reference to the attached drawing figures, wherein like reference numerals are used to refer to like elements throughout, and wherein the illustrated structures and devices are not necessarily drawn to scale. The same reference numbers may be used in different drawings to identify the same or similar elements. In the following description, for purposes of explanation and not limitation, specific details are set forth such as particular structures, architectures, interfaces, techniques, etc. in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. Embodiments herein may be related to RAN1, RAN2, 5G and the like.

As utilized herein, terms “component,” “system,” “interface,” and the like are intended to refer to a computer-related entity, hardware, software (e.g., in execution), and/or firmware. For example, a component can be a processor, a process running on a processor, a controller, an object, an executable, a program, a storage device, and/or a computer with a processing device. By way of illustration, an application running on a server and the server can also be a component. One or more components can reside within a process, and a component can be localized on one computer and/or distributed between two or more computers. A set of elements or a set of other components can be described herein, in which the term “set” can be interpreted as “one or more.”

Further, these components can execute from various computer readable storage media having various data structures stored thereon such as with a module, for example. The components can communicate via local and/or remote processes such as in accordance with a signal having one or more data packets (e.g., data from one component interacting with another component in a local system, distributed system, and/or across a network, such as, the Internet, a local area network, a wide area network, or similar network with other systems via the signal).

As another example, a component can be an apparatus with specific functionality provided by mechanical parts operated by electric or electronic circuitry, in which the electric or electronic circuitry can be operated by a software application or a firmware application executed by one or more processors. The one or more processors can be internal or external to the apparatus and can execute at least a part of the software or firmware application. As yet another example, a component can be an apparatus that provides specific functionality through electronic components without mechanical parts; the electronic components can include one or more processors therein to execute software and/or firmware that confer(s), at least in part, the functionality of the electronic components.

Use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form. Furthermore, to the extent that the terms “including”, “includes”, “having”, “has”, “with”, or variants thereof are used in either the detailed description and the claims, such terms are intended to be inclusive in a manner similar to the term “comprising”.

It is appreciated that there is a continuing need to improve data rates, reliability and performance. These techniques include phase noise compensation, including phase noise compensation for diversity based communications.

Wireless communication systems can involve nodes, such as a base station, communicating with devices, such as user equipment (UE) devices. The nodes can also include evolved Node Bs (eNBs), gNBs, and the like. The systems utilize downlink (DL) communications/transmissions from the base stations to the UE devices and uplink (UL) communications/transmissions from the UE devices to the base stations. Various techniques and schemes can be used for uplink and downlink communications.

Bandwidth parts (BWPs) indicate resource blocks designated for UL and DL communications. The resource blocks (RBs) can be carrier resource blocks (CRBs), physical resource blocks (PRBs), and the like. In one example, a BWP is a set of contiguous resource blocks.

The fifth generation of mobile technology (5G) is positioned to address the demands and business contexts of 2020 and beyond, that is, to enable a fully mobile and connected society. Long Term Evolution (LTE) and New Radio (NR) systems are two terms relating to 5G development and are used interchangeably herein, and may include Carrier Aggregation (CA), where two or more Component Carriers (CCs) are aggregated in order to support wider transmission bandwidths. Secondary Cells (SCells) can be configured to form, together with a Primary Cell (PCell), a set of serving cells. To enable reasonable user equipment (UE) battery consumption when CA is configured, an activation/deactivation mechanism of SCells is supported with Media Access Control (MAC) Control Element (CE) signaling.

The 3GPP 5G Release 15 Technical Specification (TS) 38.331, titled: “NR; Radio Resource Control (RRC); Protocol specification,” published as ETSI TS 138 331 V15.2.1 (2018-06), and its content fully incorporated herein by its reference, provide details of new features in NR CA.

One feature of NR CA includes the use of a Bandwidth Part (BWP), which is a mechanism to adaptively adjust UEs' operating bandwidth, where a UE is not required to transmit or receive outside of the configured frequency range of the active BWP, with an exception of a measurement gap. The BWP is a frequency resource that the UE can use to receive and/or transmit; for example, a physical downlink shared channel (PDSCH)/physical uplink shared channel (PUSCH) may be scheduled within an active BWP. One BWP is limited to one cell, and Multiple BWPs may be configured per cell. For a UE in RRC connected state (“RRC_CONNECTED” state), an “active” BWP is the BWP presently used for transmission/reception. The number of BWPs are configured via the RRC, and only one BWP is selected as an active BWP, by using RRC signaling or via PDCCH/DCI signaling.

Generally, each BWP is associated with a specific numerology, i.e., subcarrier spacing (SCS) and cyclic prefix (CP) type. A network can configure multiple BWPs to a UE via Radio Resource Control (RRC) signaling, which may overlap in frequency.

There are various types of BWPs used for UE operation and with a cell. These types include initial BWP, default BWP and active BWP.

The initial BWP type is typically or should be within UE bandwidth. However, it is appreciated that the initial BWP can vary from the UE bandwidth in situations, such as where interference is present.

The default BWP type can be the same or similar to the initial BWP. The default BWP can include additional network (NW) configuration.

The active BWP type is a currently active BWP. The active BWP can be changed from one BWP to another. In one example, a UE device has a single active BWP, such as in Rel15. However it is appreciated that there can be more than a single active BWP in some embodiments.

Embodiments are disclosed that facilitate configuring, reconfiguring and using BWPs for wireless communications. The embodiments include signaling and measurement for BWPs. The embodiments also include configuring and obtaining measurements for BWPs.

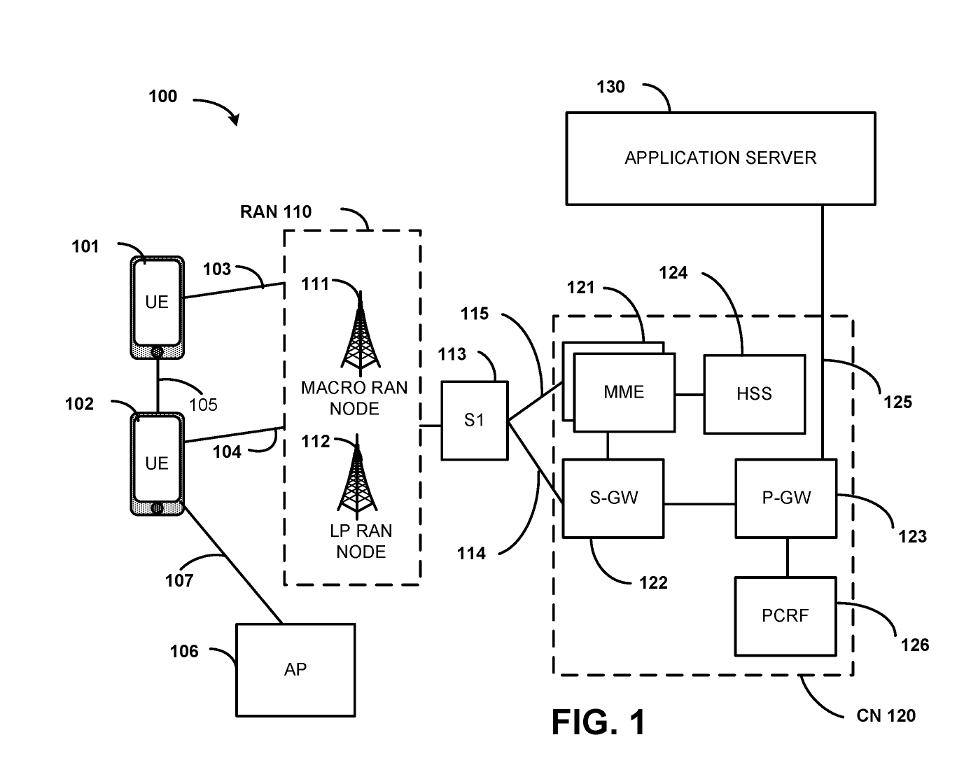

FIG. 1 illustrates an architecture of a system 100 of a network in accordance with some embodiments. The system 100 is shown to include a user equipment (UE) 101 and a UE 102. The UEs 101 and 102 are illustrated as smartphones (e.g., handheld touchscreen mobile computing devices connectable to one or more cellular networks), but can also comprise any mobile or non-mobile computing device, such as Personal Data Assistants (PDAs), pagers, laptop computers, desktop computers, wireless handsets, or any computing device including a wireless communications interface.

In some embodiments, any of the UEs 101 and 102 can comprise an Internet of Things (IoT) UE, which can comprise a network access layer designed for low-power IoT applications utilizing short-lived UE connections. An IoT UE can utilize technologies such as machine-to-machine (M2M) or machine-type communications (MTC) for exchanging data with an MTC server or device via a public land mobile network (PLMN), Proximity-Based Service (ProSe) or device-to-device (D2D) communication, sensor networks, or IoT networks. The M2M or MTC exchange of data can be a machine-initiated exchange of data. An IoT network describes interconnecting IoT UEs, which can include uniquely identifiable embedded computing devices (within the Internet infrastructure), with short-lived connections. The IoT UEs can execute background applications (e.g., keep-alive messages, status updates, etc.) to facilitate the connections of the IoT network.

The UEs 101 and 102 can be configured to connect, e.g., communicatively couple, with a radio access network (RAN) 110—the RAN 110 can be, for example, an Evolved Universal Mobile Telecommunications System (UMTS) Terrestrial Radio Access Network (E-UTRAN), a NextGen RAN (NG RAN), or some other type of RAN. The UEs 101 and 102 utilize connections 103 and 104, respectively, each of which comprises a physical communications interface or layer (discussed in further detail below); in this example, the connections 103 and 104 are illustrated as an air interface to enable communicative coupling, and can be consistent with cellular communications protocols, such as a Global System for Mobile Communications (GSM) protocol, a code-division multiple access (CDMA) network protocol, a Push-to-Talk (PTT) protocol, a PTT over Cellular (POC) protocol, a Universal Mobile Telecommunications System (UMTS) protocol, a 3GPP Long Term Evolution (LTE) protocol, a fifth generation (5G) protocol, a New Radio (NR) protocol, and the like.

In this embodiment, the UEs 101 and 102 can further directly exchange communication data via a ProSe interface 105. The ProSe interface 105 can alternatively be referred to as a sidelink interface comprising one or more logical channels, including but not limited to a Physical Sidelink Control Channel (PSCCH), a Physical Sidelink Shared Channel (PSSCH), a Physical Sidelink Discovery Channel (PSDCH), and a Physical Sidelink Broadcast Channel (PSBCH).

The UE 102 is shown to be configured to access an access point (AP) 106 via connection 107. The connection 107 can comprise a local wireless connection, such as a connection consistent with any IEEE 802.11 protocol, wherein the AP 106 would comprise a wireless fidelity (WiFi®) router. In this example, the AP 106 is shown to be connected to the Internet without connecting to the core network of the wireless system (described in further detail below).

The RAN 110 can include one or more access nodes that enable the connections 103 and 104. These access nodes (ANs) can be referred to as base stations (BSs), NodeBs, evolved NodeBs (eNBs), next Generation NodeBs (gNB), RAN nodes, and so forth, and can comprise ground stations (e.g., terrestrial access points) or satellite stations providing coverage within a geographic area (e.g., a cell). A network device as referred to herein can include any one of these APs, ANs, UEs or any other network component. The RAN 110 can include one or more RAN nodes for providing macrocells, e.g., macro RAN node 111, and one or more RAN nodes for providing femtocells or picocells (e.g., cells having smaller coverage areas, smaller user capacity, or higher bandwidth compared to macrocells), e.g., low power (LP) RAN node 112.

Any of the RAN nodes 111 and 112 can terminate the air interface protocol and can be the first point of contact for the UEs 101 and 102. In some embodiments, any of the RAN nodes 111 and 112 can fulfill various logical functions for the RAN 110 including, but not limited to, radio network controller (RNC) functions such as radio bearer management, uplink (UL) and downlink (DL) dynamic radio resource management and data packet scheduling, and mobility management.

In accordance with some embodiments, the UEs 101 and 102 can be configured to communicate using Orthogonal Frequency-Division Multiplexing (OFDM) communication signals with each other or with any of the RAN nodes 111 and 112 over a multicarrier communication channel in accordance various communication techniques, such as, but not limited to, an Orthogonal Frequency-Division Multiple Access (OFDMA) communication technique (e.g., for downlink communications) or a Single Carrier Frequency Division Multiple Access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, a downlink resource grid can be used for downlink transmissions from any of the RAN nodes 111 and 112 to the UEs 101 and 102, while uplink transmissions can utilize similar techniques. The grid can be a time-frequency grid, called a resource grid or time-frequency resource grid, which is the physical resource in the downlink in each slot. Such a time-frequency plane representation is a common practice for OFDM systems, which makes it intuitive for radio resource allocation. Each column and each row of the resource grid corresponds to one OFDM symbol and one OFDM subcarrier, respectively. The duration of the resource grid in the time domain corresponds to one slot in a radio frame. The smallest time-frequency unit in a resource grid is denoted as a resource element. Each resource grid comprises a number of resource blocks, which describe the mapping of certain physical channels to resource elements. Each resource block comprises a collection of resource elements; in the frequency domain, this can represent the smallest quantity of resources that currently can be allocated. There are several different physical downlink channels that are conveyed using such resource blocks.

The physical downlink shared channel (PDSCH) can carry user data and higher-layer signaling to the UEs 101 and 102. The physical downlink control channel (PDCCH) can carry information about the transport format and resource allocations related to the PDSCH channel, among other things. It is appreciated that an MTC physical downlink control channel (MPDCCH) and/or an enhanced physical downlink control channel (EPDCCH) can be used in placed of the PDCCH. The It can also inform the UEs 101 and 102 about the transport format, resource allocation, and H-ARQ (Hybrid Automatic Repeat Request) information related to the uplink shared channel. Typically, downlink scheduling (assigning control and shared channel resource blocks to the UE 102 within a cell) can be performed at any of the RAN nodes 111 and 112 based on channel quality information fed back from any of the UEs 101 and 102. The downlink resource assignment information can be sent on the PDCCH used for (e.g., assigned to) each of the UEs 101 and 102.

The PDCCH can use control channel elements (CCEs) to convey the control information. Before being mapped to resource elements, the PDCCH complex-valued symbols can first be organized into quadruplets, which can then be permuted using a sub-block interleaver for rate matching. Each PDCCH can be transmitted using one or more of these CCEs, where each CCE can correspond to nine sets of four physical resource elements known as resource element groups (REGs). Four Quadrature Phase Shift Keying (QPSK) symbols can be mapped to each REG. The PDCCH can be transmitted using one or more CCEs, depending on the size of the downlink control information (DCI) and the channel condition. There can be four or more different PDCCH formats defined in LTE with different numbers of CCEs (e.g., aggregation level, L=1, 2, 4, or 8).

Some embodiments can use concepts for resource allocation for control channel information that are an extension of the above-described concepts. For example, some embodiments can utilize an enhanced physical downlink control channel (EPDCCH) that uses PDSCH resources for control information transmission. The EPDCCH can be transmitted using one or more enhanced control channel elements (ECCEs). Similar to above, each ECCE can correspond to nine sets of four physical resource elements known as an enhanced resource element groups (EREGs). An ECCE can have other numbers of EREGs in some situations.

The RAN 110 is shown to be communicatively coupled to a core network (CN) 120—via an S1 interface 113. In embodiments, the CN 120 can be an evolved packet core (EPC) network, a NextGen Packet Core (NPC) network, or some other type of CN. In this embodiment the S1 interface 113 is split into two parts: the S1-U interface 114, which carries traffic data between the RAN nodes 111 and 112 and the serving gateway (S-GW) 122, and the 51-mobility management entity (MME) interface 115, which is a signaling interface between the RAN nodes 111 and 112 and MMEs 121.

In this embodiment, the CN 120 comprises the MMEs 121, the S-GW 122, the Packet Data Network (PDN) Gateway (P-GW) 123, and a home subscriber server (HSS) 124. The MMEs 121 can be similar in function to the control plane of legacy Serving General Packet Radio Service (GPRS) Support Nodes (SGSN). The MMEs 121 can manage mobility aspects in access such as gateway selection and tracking area list management. The HSS 124 can comprise a database for network users, including subscription-related information to support the network entities' handling of communication sessions. The CN 120 can comprise one or several HSSs 124, depending on the number of mobile subscribers, on the capacity of the equipment, on the organization of the network, etc. For example, the HSS 124 can provide support for routing/roaming, authentication, authorization, naming/addressing resolution, location dependencies, etc.

The S-GW 122 can terminate the S1 interface 113 towards the RAN 110, and routes data packets between the RAN 110 and the CN 120. In addition, the S-GW 122 can be a local mobility anchor point for inter-RAN node handovers and also can provide an anchor for inter-3GPP mobility. Other responsibilities can include lawful intercept, charging, and some policy enforcement.

The P-GW 123 can terminate an SGi interface toward a PDN. The P-GW 123 can route data packets between the CN network 120 and external networks such as a network including the application server 130 (alternatively referred to as application function (AF)) via an Internet Protocol (IP) interface 125. Generally, the application server 130 can be an element offering applications that use IP bearer resources with the core network (e.g., UMTS Packet Services (PS) domain, LTE PS data services, etc.). In this embodiment, the P-GW 123 is shown to be communicatively coupled to an application server 130 via an IP communications interface 125. The application server 130 can also be configured to support one or more communication services (e.g., Voice-over-Internet Protocol (VoIP) sessions, PTT sessions, group communication sessions, social networking services, etc.) for the UEs 101 and 102 via the CN 120.

The P-GW 123 can further be a node for policy enforcement and charging data collection. Policy and Charging Enforcement Function (PCRF) 126 is the policy and charging control element of the CN 120. In a non-roaming scenario, there can be a single PCRF in the Home Public Land Mobile Network (HPLMN) associated with a UE's Internet Protocol Connectivity Access Network (IP-CAN) session. In a roaming scenario with local breakout of traffic, there can be two PCRFs associated with a UE's IP-CAN session: a Home PCRF (H-PCRF) within a HPLMN and a Visited PCRF (V-PCRF) within a Visited Public Land Mobile Network (VPLMN). The PCRF 126 can be communicatively coupled to the application server 130 via the P-GW 123. The application server 130 can signal the PCRF 126 to indicate a new service flow and select the appropriate Quality of Service (QoS) and charging parameters. The PCRF 126 can provision this rule into a Policy and Charging Enforcement Function (PCEF) (not shown) with the appropriate traffic flow template (TFT) and QoS class of identifier (QCI), which commences the QoS and charging as specified by the application server 130.

In one or more embodiments, IMS services can be identified more accurately in a paging indication, which can enable the UEs 101, 102 to differentiate between PS paging and IMS service related paging. As a result, the UEs 101, 102 can apply preferential prioritization for IMS services as desired based on any number of requests by any application, background searching (e.g., PLMN searching or the like), process, or communication. In particular, the UEs 101, 102 can differentiate the PS domain paging to more distinguishable categories, so that IMS services can be identified clearly in the UEs 101, 102 in comparison to PS services. In addition to a domain indicator (e.g., PS or CS), a network (e.g., CN 120, RAN 110, AP 106, or combination thereof as an eNB or the other network device) can provide further, more specific information with the TS 36.331-Paging message, such as a “paging cause” parameter. The UE can use this information to decide whether to respond to the paging, possibly interrupting some other procedure like an ongoing PLMN search.

In one example, when UEs 101, 102 can be registered to a visited PLMN (VPLMN) and performing PLMN search (i.e., background scan for a home PLMN (HPLMN) or a higher priority PLMN), or when a registered UE is performing a manual PLMN search, the PLMN search can be interrupted in order to move to a connected mode and respond to a paging operation as part of a MT procedure/operation. Frequently, this paging could be for PS data (non-IMS data), where, for example, an application server 130 in the NW wants to push to the UE 101 or 102 for one of the many different applications running in/on the UE 101 or 102, for example. Even though the PS data could be delay tolerant and less important, in legacy networks the paging is often not able to be ignored completely, as critical services like an IMS call can be the reason for the PS paging. The multiple interruptions of the PLMN search caused by the paging can result in an unpredictable delay of the PLMN search or in the worst case even in a failure of the procedure, resulting in a loss of efficiency in network communication operations. A delay in moving to or handover to a preferred PLMN (via manual PLMN search or HPLMN search) in a roaming condition can incur more roaming charges on a user as well.

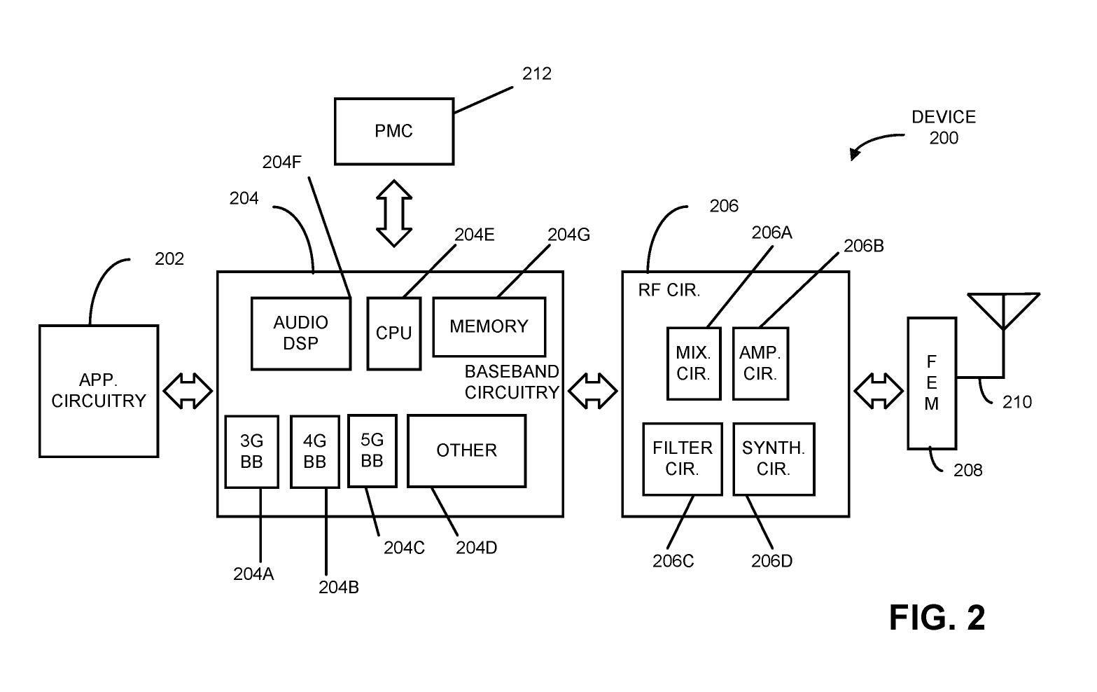

FIG. 2 illustrates example components of a network device 200 in accordance with some embodiments. In some embodiments, the device 200 can include application circuitry 202, baseband circuitry 204, Radio Frequency (RF) circuitry 206, front-end module (FEM) circuitry 208, one or more antennas 210, and power management circuitry (PMC) 212 coupled together at least as shown. The components of the illustrated device 200 can be included in a UE 101, 102 or a RAN node 111, 112, AP, AN, eNB or other network component. In some embodiments, the device 200 can include less elements (e.g., a RAN node can not utilize application circuitry 202, and instead include a processor/controller to process IP data received from an EPC). In some embodiments, the network device 200 can include additional elements such as, for example, memory/storage, display, camera, sensor, or input/output (I/O) interface. In other embodiments, the components described below can be included in more than one device (e.g., said circuitries can be separately included in more than one device for Cloud-RAN (C-RAN) implementations).

The application circuitry 202 can include one or more application processors. For example, the application circuitry 202 can include circuitry such as, but not limited to, one or more single-core or multi-core processors. The processor(s) can include any combination of general-purpose processors and dedicated processors (e.g., graphics processors, application processors, etc.). The processors can be coupled with or can include memory/storage and can be configured to execute instructions stored in the memory/storage to enable various applications or operating systems to run on the device 200. In some embodiments, processors of application circuitry 202 can process IP data packets received from an EPC.

The baseband circuitry 204 can include circuitry such as, but not limited to, one or more single-core or multi-core processors. The baseband circuitry 204 can include one or more baseband processors or control logic to process baseband signals received from a receive signal path of the RF circuitry 206 and to generate baseband signals for a transmit signal path of the RF circuitry 206. Baseband processing circuity 204 can interface with the application circuitry 202 for generation and processing of the baseband signals and for controlling operations of the RF circuitry 206. For example, in some embodiments, the baseband circuitry 204 can include a third generation (3G) baseband processor 204A, a fourth generation (4G) baseband processor 204B, a fifth generation (5G) baseband processor 204C, or other baseband processor(s) 204D for other existing generations, generations in development or to be developed in the future (e.g., second generation (2G), si2h generation (6G), etc.). The baseband circuitry 204 (e.g., one or more of baseband processors 204A-D) can handle various radio control functions that enable communication with one or more radio networks via the RF circuitry 206. In other embodiments, some or all of the functionality of baseband processors 204A-D can be included in modules stored in the memory 204G and executed via a Central Processing Unit (CPU) 204E. The radio control functions can include, but are not limited to, signal modulation/demodulation, encoding/decoding, radio frequency shifting, etc. In some embodiments, modulation/demodulation circuitry of the baseband circuitry 204 can include Fast-Fourier Transform (FFT), precoding, or constellation mapping/demapping functionality. In some embodiments, encoding/decoding circuitry of the baseband circuitry 204 can include convolution, tail-biting convolution, turbo, Viterbi, or Low Density Parity Check (LDPC) encoder/decoder functionality. Embodiments of modulation/demodulation and encoder/decoder functionality are not limited to these examples and can include other suitable functionality in other embodiments.

In some embodiments, the baseband circuitry 204 can include one or more audio digital signal processor(s) (DSP) 204F. The audio DSP(s) 204F can be include elements for compression/decompression and echo cancellation and can include other suitable processing elements in other embodiments. Components of the baseband circuitry can be suitably combined in a single chip, a single chipset, or disposed on a same circuit board in some embodiments. In some embodiments, some or all of the constituent components of the baseband circuitry 204 and the application circuitry 202 can be implemented together such as, for example, on a system on a chip (SOC).

In some embodiments, the baseband circuitry 204 can provide for communication compatible with one or more radio technologies. For example, in some embodiments, the baseband circuitry 204 can support communication with an evolved universal terrestrial radio access network (EUTRAN) or other wireless metropolitan area networks (WMAN), a wireless local area network (WLAN), a wireless personal area network (WPAN). Embodiments in which the baseband circuitry 204 is configured to support radio communications of more than one wireless protocol can be referred to as multi-mode baseband circuitry.

RF circuitry 206 can enable communication with wireless networks using modulated electromagnetic radiation through a non-solid medium. In various embodiments, the RF circuitry 206 can include switches, filters, amplifiers, etc. to facilitate the communication with the wireless network. RF circuitry 206 can include a receive signal path which can include circuitry to down-convert RF signals received from the FEM circuitry 208 and provide baseband signals to the baseband circuitry 204. RF circuitry 206 can also include a transmit signal path which can include circuitry to up-convert baseband signals provided by the baseband circuitry 204 and provide RF output signals to the FEM circuitry 208 for transmission.

In some embodiments, the receive signal path of the RF circuitry 206 can include mixer circuitry 206a, amplifier circuitry 206b and filter circuitry 206c. In some embodiments, the transmit signal path of the RF circuitry 206 can include filter circuitry 206c and mixer circuitry 206a. RF circuitry 206 can also include synthesizer circuitry 206d for synthesizing a frequency for use by the mixer circuitry 206a of the receive signal path and the transmit signal path. In some embodiments, the mixer circuitry 206a of the receive signal path can be configured to down-convert RF signals received from the FEM circuitry 208 based on the synthesized frequency provided by synthesizer circuitry 206d. The amplifier circuitry 206b can be configured to amplify the down-converted signals and the filter circuitry 206c can be a low-pass filter (LPF) or band-pass filter (BPF) configured to remove unwanted signals from the down-converted signals to generate output baseband signals. Output baseband signals can be provided to the baseband circuitry 204 for further processing. In some embodiments, the output baseband signals can be zero-frequency baseband signals, although this is not a requirement. In some embodiments, mixer circuitry 206a of the receive signal path can comprise passive mixers, although the scope of the embodiments is not limited in this respect.

In some embodiments, the mixer circuitry 206a of the transmit signal path can be configured to up-convert input baseband signals based on the synthesized frequency provided by the synthesizer circuitry 206d to generate RF output signals for the FEM circuitry 208. The baseband signals can be provided by the baseband circuitry 204 and can be filtered by filter circuitry 206c.

In some embodiments, the mixer circuitry 206a of the receive signal path and the mixer circuitry 206a of the transmit signal path can include two or more mixers and can be arranged for quadrature downconversion and upconversion, respectively. In some embodiments, the mixer circuitry 206a of the receive signal path and the mixer circuitry 206a of the transmit signal path can include two or more mixers and can be arranged for image rejection (e.g., Hartley image rejection). In some embodiments, the mixer circuitry 206a of the receive signal path and the mixer circuitry 206a can be arranged for direct downconversion and direct upconversion, respectively. In some embodiments, the mixer circuitry 206a of the receive signal path and the mixer circuitry 206a of the transmit signal path can be configured for super-heterodyne operation.

In some embodiments, the output baseband signals and the input baseband signals can be analog baseband signals, although the scope of the embodiments is not limited in this respect. In some alternate embodiments, the output baseband signals and the input baseband signals can be digital baseband signals. In these alternate embodiments, the RF circuitry 206 can include analog-to-digital converter (ADC) and digital-to-analog converter (DAC) circuitry and the baseband circuitry 204 can include a digital baseband interface to communicate with the RF circuitry 206.

In some dual-mode embodiments, a separate radio IC circuitry can be provided for processing signals for each spectrum, although the scope of the embodiments is not limited in this respect.

In some embodiments, the synthesizer circuitry 206d can be a fractional-N synthesizer or a fractional N/N+1 synthesizer, although the scope of the embodiments is not limited in this respect as other types of frequency synthesizers can be suitable. For example, synthesizer circuitry 206d can be a delta-sigma synthesizer, a frequency multiplier, or a synthesizer comprising a phase-locked loop with a frequency divider.

The synthesizer circuitry 206d can be configured to synthesize an output frequency for use by the mixer circuitry 206a of the RF circuitry 206 based on a frequency input and a divider control input. In some embodiments, the synthesizer circuitry 206d can be a fractional N/N+1 synthesizer.

In some embodiments, frequency input can be provided by a voltage controlled oscillator (VCO), although that is not a requirement. Divider control input can be provided by either the baseband circuitry 204 or the applications processor 202 depending on the desired output frequency. In some embodiments, a divider control input (e.g., N) can be determined from a look-up table based on a channel indicated by the applications processor 202.

Synthesizer circuitry 206d of the RF circuitry 206 can include a divider, a delay-locked loop (DLL), a multiplexer and a phase accumulator. In some embodiments, the divider can be a dual modulus divider (DMD) and the phase accumulator can be a digital phase accumulator (DPA). In some embodiments, the DMD can be configured to divide the input signal by either N or N+1 (e.g., based on a carry out) to provide a fractional division ratio. In some example embodiments, the DLL can include a set of cascaded, tunable, delay elements, a phase detector, a charge pump and a D-type flip-flop. In these embodiments, the delay elements can be configured to break a VCO period up into Nd equal packets of phase, where Nd is the number of delay elements in the delay line. In this way, the DLL provides negative feedback to help ensure that the total delay through the delay line is one VCO cycle.

In some embodiments, synthesizer circuitry 206d can be configured to generate a carrier frequency as the output frequency, while in other embodiments, the output frequency can be a multiple of the carrier frequency (e.g., twice the carrier frequency, four times the carrier frequency) and used in conjunction with quadrature generator and divider circuitry to generate multiple signals at the carrier frequency with multiple different phases with respect to each other. In some embodiments, the output frequency can be a LO frequency (fLO). In some embodiments, the RF circuitry 206 can include an IQ/polar converter.

FEM circuitry 208 can include a receive signal path which can include circuitry configured to operate on RF signals received from one or more antennas 210, amplify the received signals and provide the amplified versions of the received signals to the RF circuitry 206 for further processing. FEM circuitry 208 can also include a transmit signal path which can include circuitry configured to amplify signals for transmission provided by the RF circuitry 206 for transmission by one or more of the one or more antennas 210. In various embodiments, the amplification through the transmit or receive signal paths can be done solely in the RF circuitry 206, solely in the FEM 208, or in both the RF circuitry 206 and the FEM 208.

In some embodiments, the FEM circuitry 208 can include a TX/RX switch to switch between transmit mode and receive mode operation. The FEM circuitry can include a receive signal path and a transmit signal path. The receive signal path of the FEM circuitry can include an LNA to amplify received RF signals and provide the amplified received RF signals as an output (e.g., to the RF circuitry 206). The transmit signal path of the FEM circuitry 208 can include a power amplifier (PA) to amplify input RF signals (e.g., provided by RF circuitry 206), and one or more filters to generate RF signals for subsequent transmission (e.g., by one or more of the one or more antennas 210).

In some embodiments, the PMC 212 can manage power provided to the baseband circuitry 204. In particular, the PMC 212 can control power-source selection, voltage scaling, battery charging, or DC-to-DC conversion. The PMC 212 can often be included when the device 200 is capable of being powered by a battery, for example, when the device is included in a UE. The PMC 212 can increase the power conversion efficiency while providing desirable implementation size and heat dissipation characteristics.

While FIG. 2 shows the PMC 212 coupled only with the baseband circuitry 204. However, in other embodiments, the PMC 2 12 can be additionally or alternatively coupled with, and perform similar power management operations for, other components such as, but not limited to, application circuitry 202, RF circuitry 206, or FEM 208.

In some embodiments, the PMC 212 can control, or otherwise be part of, various power saving mechanisms of the device 200. For example, if the device 200 is in an RRC_Connected state, where it is still connected to the RAN node as it expects to receive traffic shortly, then it can enter a state known as Discontinuous Reception Mode (DRX) after a period of inactivity. During this state, the device 200 can power down for brief intervals of time and thus save power.

If there is no data traffic activity for an extended period of time, then the device 200 can transition off to an RRC_Idle state, where it disconnects from the network and does not perform operations such as channel quality feedback, handover, etc. The device 200 goes into a very low power state and it performs paging where again it periodically wakes up to listen to the network and then powers down again. The device 200 does not receive data in this state, in order to receive data, it transitions back to RRC_Connected state.

An additional power saving mode can allow a device to be unavailable to the network for periods longer than a paging interval (ranging from seconds to a few hours). During this time, the device can be unreachable to the network and can power down completely. Any data sent during this time can incur a large delay with the delay presumed to be acceptable.

Processors of the application circuitry 202 and processors of the baseband circuitry 204 can be used to execute elements of one or more instances of a protocol stack. For example, processors of the baseband circuitry 204, alone or in combination, can be used execute Layer 3, Layer 2, or Layer 1 functionality, while processors of the application circuitry 204 can utilize data (e.g., packet data) received from these layers and further execute Layer 4 functionality (e.g., transmission communication protocol (TCP) and user datagram protocol (UDP) layers). As referred to herein, Layer 3 can comprise a radio resource control (RRC) layer, described in further detail below. As referred to herein, Layer 2 can comprise a medium access control (MAC) layer, a radio link control (RLC) layer, and a packet data convergence protocol (PDCP) layer, described in further detail below. As referred to herein, Layer 1 can comprise a physical (PHY) layer of a UE/RAN node. Each of these layers can be implemented to operate one or more processes or network operations of embodiments/aspects herein.

In addition, the memory 204G can comprise one or more machine-readable medium/media including instructions that, when performed by a machine or component herein cause the machine to perform acts of the method or of an apparatus or system for concurrent communication using multiple communication technologies according to embodiments and examples described herein. It is to be understood that aspects described herein can be implemented by hardware, software, firmware, or any combination thereof. When implemented in software, functions can be stored on or transmitted over as one or more instructions or code on a computer-readable medium (e.g., the memory described herein or other storage device). Computer-readable media includes both computer storage media and communication media including any medium that facilitates transfer of a computer program from one place to another. A storage media or a computer readable storage device can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or other tangible and/or non-transitory medium, that can be used to carry or store desired information or executable instructions. Also, any connection can also be termed a computer-readable medium. For example, if software is transmitted from a website, server, or other remote source using a coaxial cable, fiber optic cable, twisted pair, digital subscriber line (DSL), or wireless technologies such as infrared, radio, and microwave, then coaxial cable, fiber optic cable, twisted pair, DSL, or wireless technologies such as infrared, radio, and microwave are included in the definition of medium.

In general, there is a move to provide network services for the packet domain. The earlier network services like UMTS or 3G and predecessors (2G) configured a CS domain and a packet domain providing different services, especially CS services in the CS domain as well as voice services were considered to have a higher priority because consumers demanded an immediate response. Based on the domain that the paging was received, the device 200 could assign certain priority for the incoming transaction. Now with LTE/5G most services are moving to the packet domain. Currently, the UE (e.g., 101, 102, or device 200) can get paging for a packet service without knowing any further information about the paging of the MT procedure, such as whether someone is calling on a line, a VoIP call, or just some packet utilized from Facebook, other application service, or other similar MT service. As such, a greater opportunity exists for further delays without the possibility for the UE to discriminate between the different application packets that could initiate a paging and also give a different priority to it based on one or more user preferences. This can could be important for the UE because the UE might be doing other tasks more vital for resource allocation.

In one example, a UE (e.g., 101, 102, or device 200) could be performing a background search for other PLMNs. This is a task the UE device 200 could do in regular intervals if it is not connected on its own home PLMN or a higher priority PLMN, but roaming somewhere else. A higher priority could be a home PLMN or some other PLMNs according to a list provided by the provider or subscriber (e.g., HSS 124). Consequently, if a paging operation arrives as an MT service and an interruption results, such that a start and begin operation are executed, a sufficient frequency of these interruptions could cause the UE to never complete a background search in a reasonable way. This is one way where it would be advantageous for the UE or network device to know that the interruption is only a packet service, with no need to react to it immediately, versus an incoming voice call that takes preference immediately and the background scan should be postponed.

Additionally, the device 200 can be configured to connect or include multiple subscriber identity/identification module (SIM) cards/components, referred to as dual SIM or multi SIM devices. The device 200 can operate with a single transmit and receive component that can coordinate between the different identities from which the SIM components are operating. As such, an incoming voice call should be responded to as fast as possible, while only an incoming packet for an application could be relatively ignored in order to utilize resources for the other identity (e.g., the voice call or SIM component) that is more important or has a higher priority from a priority list/data set/or set of user device preferences, for example. This same scenario can also be utilized for other operations or incoming data, such as with a PLMN background search such as a manual PLMN search, which can last for a long period of time since, especially with a large number of different bands from 2G, etc. With an ever increasing number of bands being utilized in wireless communications, if paging interruptions come in between the operations already running without distinguishing between the various packet and real critical services such as voice, the network devices can interpret this manual PLMN search to serve and ensure against a drop or loss of any increment voice call, with more frequent interruptions in particular.

As stated above, even though in most of these cases the PS data is delay tolerant and less important, in legacy networks the paging cannot be ignored completely, as critical services like an IMS call can be the reason for the PS paging. The multiple interruptions of a PLMN search caused by the paging can result in an unpredictable delay of the PLMN search or in the worst case even in a failure of the procedure. Additionally, a delay in moving to preferred PLMN (via manual PLMN search or HPLMN search) in roaming condition can incur more roaming charges on user. Similarly, in multi-SIM scenario when UE is listening to paging channel of two networks simultaneously and has priority for voice service, a MT IMS voice call can be interpreted as “data” call as indicated in MT paging message and can be preceded by MT Circuit Switched (CS) paging of an other network or MO CS call initiated by user at same time. As such, embodiments/aspects herein can increase the call drop risk significantly for the SIM using IMS voice service.

In embodiments, 3GPP NW can provide further granular information about the kind of service the network is paging for. For example, the Paging cause parameter could indicate one of the following values/classes/categories: 1) IMS voice/video service; 2) IMS SMS service; 3) IMS other services (not voice/video/SMS-related; 4) any IMS service; 5) Other PS service (not IMS-related). In particular, a network device (e.g., an eNB or access point) could only be discriminating between IMS and non-IMS services could use 4) and 5), whereas a network that is able to discriminate between different types of IMS services (like voice/video call, SMS, messaging, etc.) could use 3) instead of 4) to explicitly indicate to the UE that the paging is for an IMS service different from voice/video and SMS. By obtaining this information UE may decide to suspend PLMN search only for critical services like incoming voice/video services.

In other aspects, dependent on the service category (e.g., values or classes 1-5 above), the UE 101, 102, or device 200 can memorize that there was a paging to which it did not respond, and access the network later, when the PLMN search has been completed and the UE decides to stay on the current PLMN. For example, if the reason for the paging was a mobile terminating IMS SMS, the MME can then inform the HSS (e.g., 124) that the UE is reachable again, and the HSS 124 can initiate a signaling procedure which will result in a delivery of the SMS to the UE once resources are more available or less urgent for another operation/application/or category, for example. To this purpose the UE 101, 102, or 200 could initiate a periodic tau area update (TAU) procedure if the service category in the Paging message indicated “IMS SMS service”, for example.

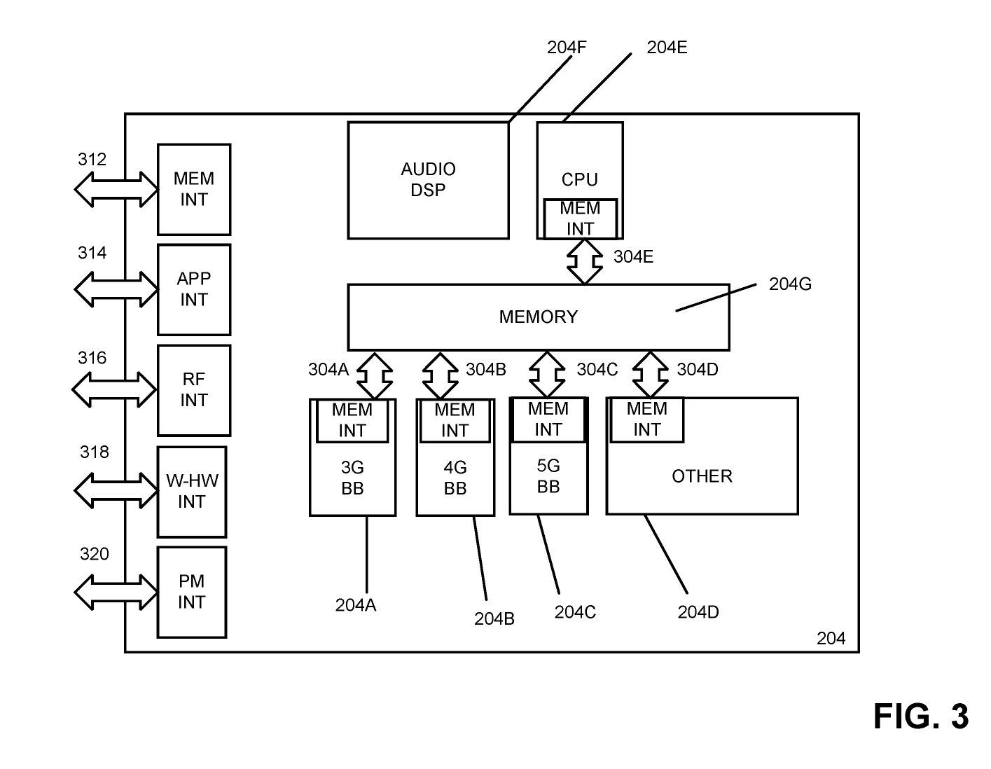

FIG. 3 illustrates example interfaces of baseband circuitry in accordance with some embodiments. As discussed above, the baseband circuitry 204 of FIG. 2 can comprise processors 204A-204E and a memory 204G utilized by said processors. Each of the processors 204A-204E can include a memory interface, 304A-304E, respectively, to send/receive data to/from the memory 204G.

The baseband circuitry 204 can further include one or more interfaces to communicatively couple to other circuitries/devices, such as a memory interface 312 (e.g., an interface to send/receive data to/from memory external to the baseband circuitry 204), an application circuitry interface 314 (e.g., an interface to send/receive data to/from the application circuitry 202 of FIG. 2), an RF circuitry interface 316 (e.g., an interface to send/receive data to/from RF circuitry 206 of FIG. 2), a wireless hardware connectivity interface 318 (e.g., an interface to send/receive data to/from Near Field Communication (NFC) components, Bluetooth® components (e.g., Bluetooth® Low Energy), Wi-Fi® components, and other communication components), and a power management interface 320 (e.g., an interface to send/receive power or control signals to/from the PMC 212.

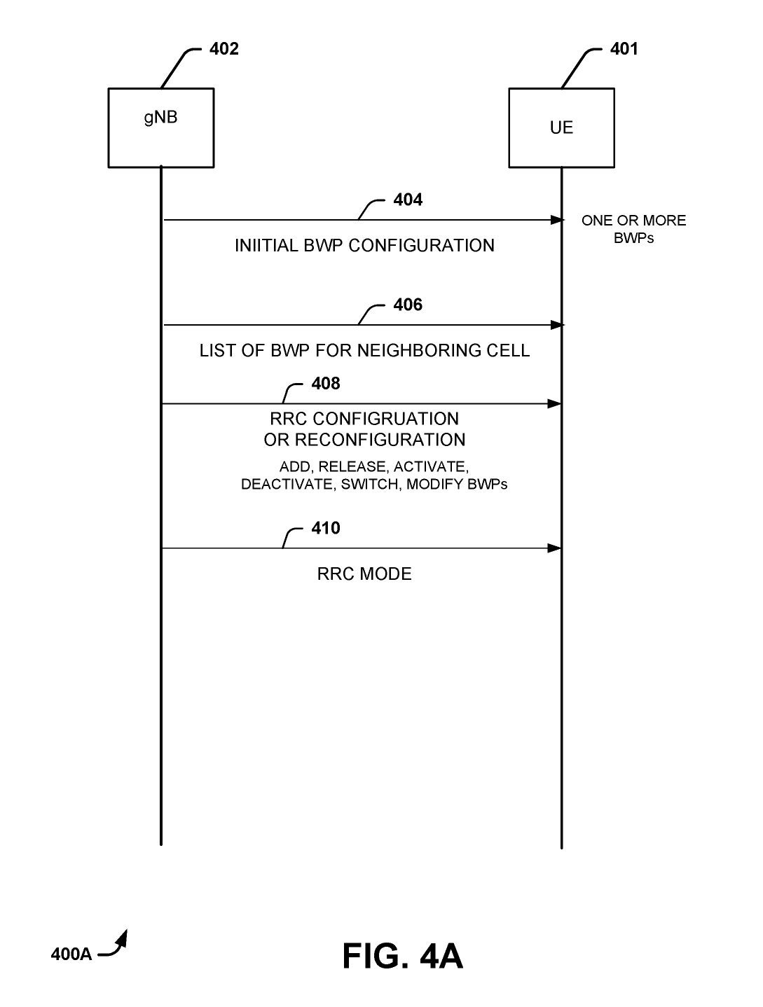

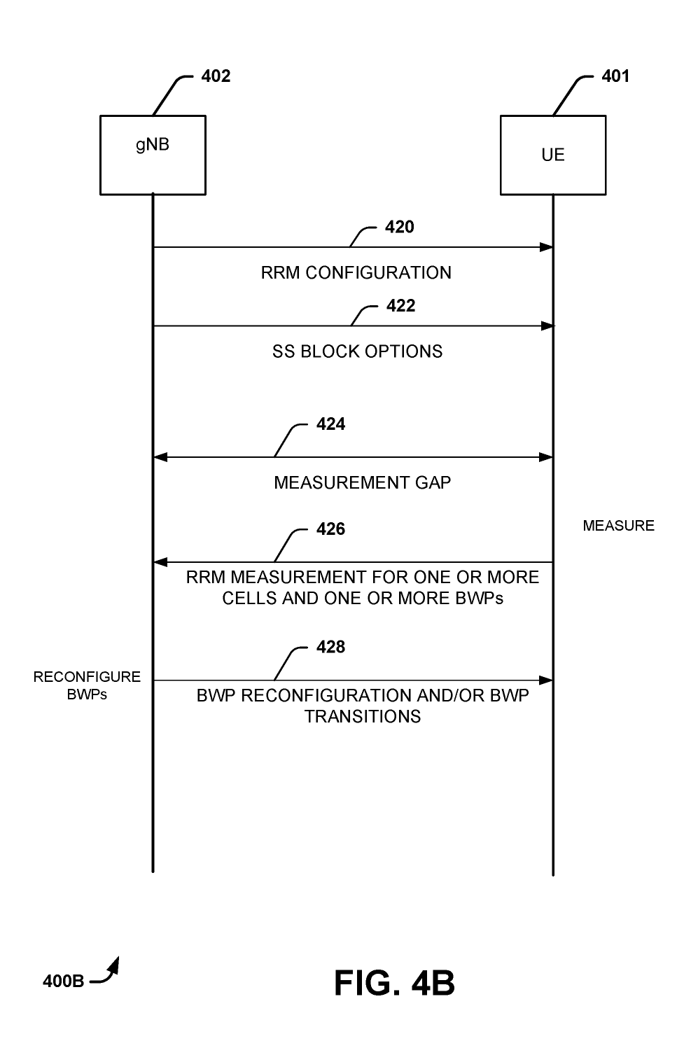

FIGS. 4A and 4B provide a diagram illustrating an architecture of a system 400 that facilitates use of bandwidth parts (BWPs) and measurement in accordance with some embodiments. The system or apparatus 400 can be utilized with the above embodiments and variations thereof, including the system 100 described above. The system 400 is provided as an example and it is appreciated that suitable variations are contemplated.

FIG. 4A provides a diagram illustrating an architecture of a portion 400A of the system 400 in accordance with some embodiments.

FIG. 4B provides a diagram illustrating another portion 400B of the system. The system including 400A and 400B is collectively referred to as 400.

The system 400 includes a network device 401 and a node 402. The device 401 is shown as a UE device and the node 402 is shown as gNB for illustrative purposes. It is appreciated that the UE device 401 can be other network devices, such as APs, ANs and the like. It is also appreciated that the gNB 402 can be other nodes or access nodes (ANs), such as a base station (BS), eNB, gNB, RAN nodes, UE and the like. Other network or network devices can be present and interact with the device 401 and/or the node 402. Operation of the device 401 and/or the node 402 can be performed by circuitry, such as the baseband circuitry 204, described above.

Generally, downlink (DL) transmissions occur from the gNB 402 to the UE 401 whereas uplink (UL) transmissions occur from the UE 401 to the gNB 402. The downlink transmissions typically utilize a DL control channel and a DL data channel. The uplink transmissions typically utilize an UL control channel and a UL data channel. The various channels can be different in terms of direction, link to another gNB, eNB and the like.

The UE 401 is one of a set or group of UE devices assigned to or associated with a cell of the gNB 402. The UE 401 can be configured with a secondary cell group (SCG) and/or a master cell group (MCG). Within a cell group, there can be a primary cell, secondary cell, serving cell and the like that belong with the group. The UE 401 can be associated or configured with one or more cell within the cell group.

Resources for the UE 401 can be allocated for UL and/or DL communications/transmissions. One allocation of resources in terms of bandwidth parts (BWPs).

AS described above, BWPs indicate resource blocks designated for UL and DL communications. The resource blocks (RBs) can be carrier resource blocks (CRBs), physical resource blocks (PRBs), and the like. In one example, a BWP is a set of contiguous resource blocks.

The UE 401 has a set or plurality of BWPs for operation with the gNB 402. The BWPs can be for a cell or serving cell. Additionally, the BWPs can include downlink (DL) BWPs and uplink (UL) BWPs.

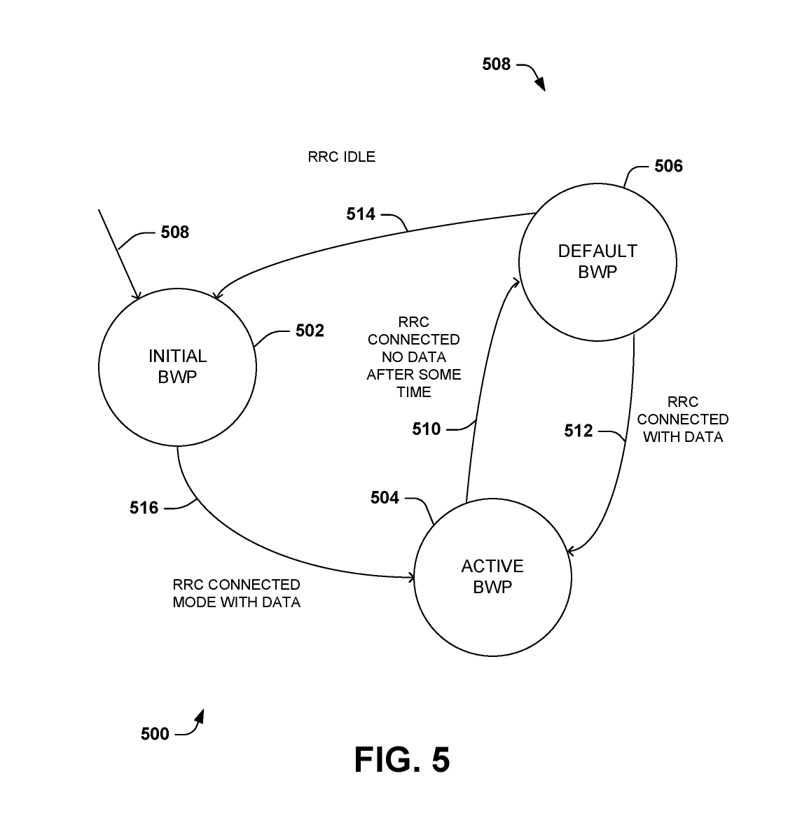

There are various types or states of BWPs used for UE 401 operation. These types include initial BWP, default BWP and active BWP as shown below in FIG. 5. BWPs can also be activated (active) and/or deactivated (deactive). Signaling, such as RRC signaling, can be used to alter the states of BWPs.

The UE 401 obtains a BWP configuration at 404. The BWP configuration can include and/or identify the plurality of BWPs. The BWP configuration can include numerology; such as subcarrier spacing (SCS), cyclic prefix type, and the like. The BWP configuration can also include or specify an initial BWP, which is the BWP that the UE 401 initially uses for communication with the gNB 402.

The BWP configuration can be in the form of and/or include a BWP information element (IE). IE include fields and values for a particular BWP. Additional examples and details for BWP IE are provided below.

The BWP configuration can also be provided, at least in part, by signaling, such as higher layer signaling, RRC signaling and the like.

The BWP configuration can also be provided, at least in part, in broadcast or downlink information, such as a system information block (SIB), downlink control information (DCI) and the like. This information can be provided in a control channel, such as PDCCH or ePDCCH.

The UE 401 is configured for operation in BWPs of a serving cell, which includes the gNB 402. The BWP configuration can be provided or configured by higher layers for the serving cell to have a plurality or set of at most fourth BWPs for reception by the UE 401 (DL BWP set), specified in a DL bandwidth by parameter BWP-Downlink and a set of at most four BWPs for transmissions by the UE 401 (UL BWP set) in an UL bandwidth by parameter BWP-Uplink for the serving cell.

An initial active DL BWP is defined by a location and number of contiguous PRBs, a subcarrier spacing and a cyclic prefix.

The BWP configuration can be broadcast by the gNB 402, such as in a system information block (SIB). In another example, a serving cell or the gNB 402 sends the BWP configuration, which includes a list of initial BWPs and initial BWPs of neighboring cells to the UE 401 as shown at 406.

The BWP configuration and reconfiguration can also be provided using radio resource control (RRC) signaling as shown at 408.

The RRC signaling can determine and/or set a status/type for each BWP of the plurality of BWPs for the UE 401. For example, a BWP can be set to active or default.

The RRC signaling can also add and release BWPs to/from the plurality of BWPs for the UE 401.

The RRC signaling can provide modifications to the plurality of BWPs for the UE 401. The signaling can indicate a number of BWPs and/or to define the information element (IE). The signaling can provide the initial configuration and BWP activation.

The BWP configuration can also provide or include DCI based BWP activation and deactivation and timer based switching or activation of BWPs.

In one example, an indication or signal is used to indicate that initial BWP if different from BW. The indication can be an explicit indication in the physical broadcast channel (PBCH) or in the remaining minimum system information (RMSI). The indication can be an implicit indication by, for example, using a common control resource set (CORSET) configuration for RMSI, which is indicated in the PBCH. The implicit indication can be indicated in the PBCH as a frequency position of the CORESET with respect to a synchronization signal (SS) block, which could imply that the initial BWP is the BWP that encloses the CORESET and SS block.

The default BWP type can be the same or similar to the initial BWP. The default BWP can include additional network (NW) configuration.

The active BWP type is the currently active or used BWP. Generally, a UE device has a single active BWP.

For the active BWP, the downlink control information (DCI), radio resource control (RRC), timer and the like are agreed or in agreement.

UL and DL activation/deactivation can be separate.

The UE 401 can be provided with the initial BWP in a variety of suitable techniques.

RRC signaling at 408 can be used to provide BWP indications and/or information. Generally, for each UE-specific DL/UL serving cell, a set of DL/UL BWP configurations are signaled to a UE by RRC-layer signaling, respectively. A DL/UL serving cell is active for a UE, such as the UE 401, if at least one of its DL/UL bandwidth parts is active.

The BWPs can include signals for measuring, such as synchronization signals. For example, the BWPs can include a synchronization signal (SS) block. In one example, the default BWP can be connected for synchronization signals (SS) block measurement, paging for DL, RACH for UL, and the like.

The UE 401 can perform RRM measurements for a BWP using a SS block of the BWP. A measurement gap 424 can be used to locate signals, such as the SS block. Additionally, the measurement gap can be used to locate signals outside of the set/plurality of BWPs and/or an active BWP. SS block options 422 identify the location of the SS block.

The obtained RRM measurement can include Channel Quality Indicator (CQI), Reference Signal Received Power (RSRP), Reference Signal Received Quality (RSRQ), Carrier Received Signal Strength Indicator (RSSI), Signal to Interference plus Noise Ratio (SINR) and the like.

An RRM measurement configuration 420 is provided to the UE 401. The measurement configuration 420 can be provided by higher layer signaling, information, and the like.

The configuration 420 can include options, such as information for SS block transmission in relation of BWP for RRM measurement. The options include the SS block options 422 for the location and indication of an SS block.

In one option, an SS block for measurement is located in the initial BWP for the UE 401. For this option, no RRM reconfiguration is performed when the UE 401 transitions between different BWPs. The UE 401 performs a RRM measurement on or using the SS block located in the initial BWP. Additionally, the RRM configuration can be independent of BWP. However, a measurement gap can be required when data is in the active BWP while performing measurements in the initial BWP.

In another option, the network configures a SS block for measurement on the active BWP. For this option, the UE 401 may not require or use a measurement gap when it is in the active BWP since both data and measurement will be on the same BWP. However, channel quality may not be consistent due to the dynamically activation/ deactivation. Additionally, when the UE 401 goes back to default BWP during no data transmission, the UE 401 is either reconfigured to measure on the initial BWP or the UE is assumed to continue to perform measurement on the active BWP.

In a third option, the network configures a SS block for measurement on any configured BWP or the set of BWPs for the UE 401. For this option, the UE 401 may not use or require a measurement gap when it the SS block is in an active BWP since both data and measurement will be on the same BWP. However, channel quality may not be consistent. Further, the network may reconfigure RRM measurement for every activation/ deactivation. If the BWP is not active, a measurement gap may still be needed.

It is appreciated that other suitable options/configurations for RRM measurement and the SS block are contemplated.

The UE 401 can transition from one BWP to another during operation. The currently used BWP is referred to as the active BWP. When the UE 401 transitions from one BWP to another BWP, the RRM measurement configuration can be different. For example, the measurement gap for a serving cell and the measurement gap for neighbouring cells may be different. This measurement gap can depend on whether the current/active BWP for the UE 401 is the same as the measurement gap and associated BWP specified in the measurement configuration. Following LTE, RRC reconfiguration is performed reconfigure measurement gap per activation or deactivation. However, if activation and deactivation are done in DCI, RRC reconfiguration can be slow and result in large signal overhead.

Several approaches can be used for measuring a serving cell to obtain the RRM measurement 426.

In a first approach for RRM measurement, the UE 401 autonomously performs serving cell RRM measurement using the measurement configuration 420, which includes the location of the SS block. For this approach, the UE 401 can obtain the RRM measurement without a measurement gap reconfiguration via RRC. If the SS block is at the active BWP of the UE 401, then the UE 401 can RX/TX data at the same time as measurement. If the SS block is not located at the active BWP, the UE 401 can autonomously perform the RRM measurement and come back to the current BWP without gap reconfiguration. The network/gNB 402 will avoid sending data to the UE 401 during the time the UE 401 is performing the RRM measurement to obtain the RRM measurement. It is appreciated that some timing/periodicity of the serving cell measurement can be defined.

In a second approach for RRM measurement, the Network configures a SS block on the active BWP. In this approach, even if the UE 401 is in a default BWP that does not have a SS block configured (since there is no data), the configured SS block on the active BWP can be used by the UE 401 to perform and obtain the RRM measurement.

In a third approach for RRM measurement, the UE 401 performs serving cell measurement if the current active BWP contains a SS block. Otherwise, the UE uses a measurement gap to locate the SS block and perform RRM measurement for the serving cell.

The UE 401 can also perform the RRM measurement for neighboring cells using the RRM configuration 420. The measurement gap may or may not be used based on which BWP is used. Several options for performing the RRM measurement and using the measurement gap are shown below.

For a first option (Option A) to perform the RRM measurement for a neighboring cell, All SS blocks of intra-frequency cells are located in the same center frequency (e.g., the initial BWP). In this option, the UE 401 can perform measurement of all cells using the same center frequency. The measurement gap can be omitted or not used to perform the measurement if the current BWP for the UE 401 includes the SS block.

For a second option (Option B) to perform the RRM measurement for a neighboring cell, the network configures some parameters for RRM measurement, such as the measurement gap per BWP or for each BWP. This options assumes consistent SS block configuration across different BWPs where the difference is gap configuration

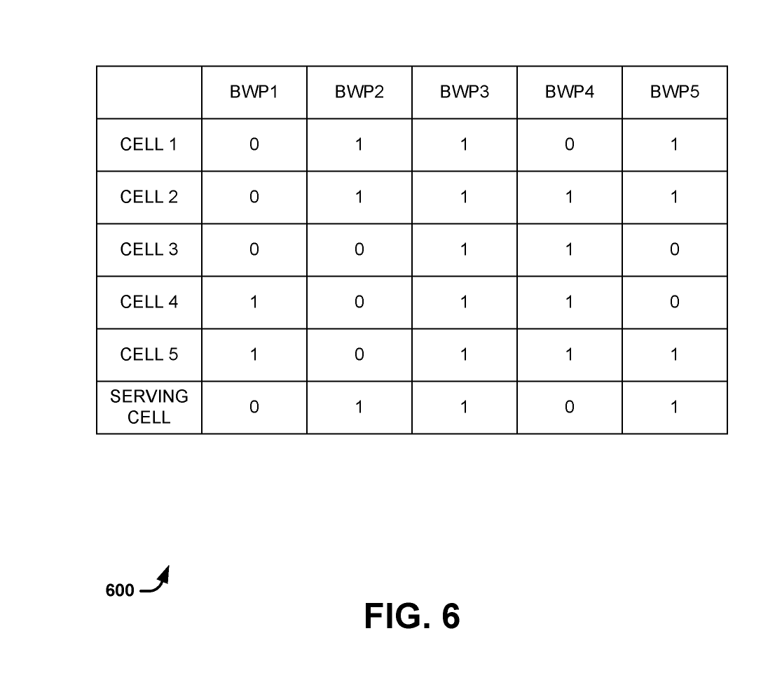

In on example, 1 bit is used to indicate if a gap is used or not per cell per BWP. For example, if the serving cell has configured 5 BWP and the same intra-frequency measurement has 5 cells, an example configuration is shown in FIG. 6.

This example shows “1” uses a gap and “0” doesn't use gap when the UE is in each BWP of the serving cell and performing measurement on each cell on the same frequency. This information can be in the measurement configuration and the UE applies accordingly based on current BWP.

For a third option to perform RRM measurement for a neighboring cell (Option C), if the combination of the cell and the BWP require a measurement gap, the network configures the measurement gap.

Upon receiving the RRM measurement, the gNB 402 can reconfigure 428 the BWPs for the UE 401 based on the received RRM measurement.

The system 400 is described using SS and the SS block. However, it is appreciated that other suitable signals and signal arrangements can be used for measurement.

Further, it is appreciated that suitable variations of the system 400 are contemplated.

FIG. 5 is a diagram illustrating types of BWPs 500 and BWP transitions for a UE device in accordance with some embodiments. The diagram depicts the BWPs 500 and also illustrates transitions between BWPs 500. The types of BWPs 500 can be used with the system 400 and variations thereof.

As stated above, there can be a plurality of BWPs for the UE 401. In one example, there are a total of 4 BWPs. In another example, there are more than four BWPs. The BWPs can be set or configured as initial, active or default, in one example.

The BWP transitions are based at least partially on a mode.

In this example, there is an initial BWP 502, an active BWP 504 and a default BWP 506.

At startup or setup, the UE device 401 transitions to or starts 508 with the initial BWP 502.

The UE 401 transitions 516 from the initial BWP 502 to the active BWP 504 when radio resource control (RRC) indicates the UE 401 is in a connected mode with data. This is the RRC connected mode with data.

The UE 401 transitions 510 from the active BWP 504 to the default BWP 506 when the UE 401 is connected, but without data for a period of time or duration. This mode is RRC connected with no data.

The UE 401 transitions 512 from the default BWP 506 back to the active BWP 504 when there is data being transferred. This mode is the RRC connected with data.

The UE 401 transitions 514 from the default BWP 506 to the initial BWP when there is no connection and data. This mode is referred to as an idle mode or RRC idle mode.

Generally, RRC signals can be used to set or transition states for BWPs.

The BWPs 500 and the accompanying description are provided as examples for illustrative purposes. It is appreciated that suitable variations are contemplated.

FIG. 6 is a table 600 depicting measurement configurations for BWPs and cells in accordance with some embodiments. The table 600 is provided for illustrative purposes and it is appreciated that other configurations and suitable variations are contemplated.

The table 600 can be used or referenced by the system 400 to determine whether a measurement gap is used to obtain and/or perform a RRM measurement of a BWP.

The table 600 depicts a 1 bit that indicates if a measurement gap is used according to a cell and/or BWP. A first column or header column includes a serving cell and various neighboring cells. A first row or header row includes a plurality of bandwidth parts for a UE device, such as the UE 401.

A value of ‘1’ indicates that the measurement gap is used or needed for the corresponding cell and bandwidth part. A value of ‘0’ indicates that the measurement gap is not used or needed for the corresponding cell and bandwidth part.

For example, the first cell (Cell 1) and BWP2 use a measurement gap to obtain RRM measurement(s).

As another example, the fifth cell (Cell 5) and BWP4 do not use or need a measurement gap to obtain RRM measurement(s).

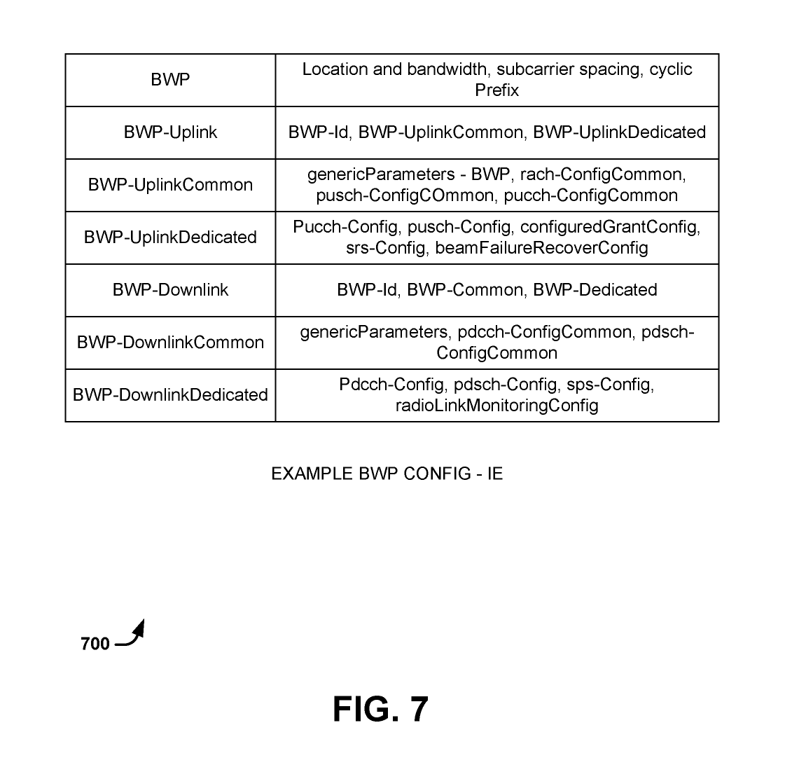

FIG. 7 is a diagram illustrating an example BWP configuration 700 in accordance with some embodiments. The configuration 700 is in the form of a BWP information element (IE). The configuration can be used as or part of the BWP configuration in the system 400.

The configuration 400 shows various fields and subfields that can be used. It is appreciated that other configurations, fields, subfields, values and the like are contemplated.

BWP IE 700, in this example, includes fields or main fields and associated subfiels. The main fields are shown in a first column and the associated fields are shown in a second column.

The configuration 700 includes BWP fields of cyclicPrefix, locationAndBandwidth and subcarrierSpacing.

The cyclicPrefix field indicates whether to use an extended cyclic prefix for this bandwidth part. If not set, the UE uses the normal cyclic prefix. Normal CP is supported for all numerologies and slot formats. Extended CP is supported only for 60 kHz subcarrier spacing.

The locationAndBandwidth indicates the Frequency domain location and bandwidth of a bandwidth part.

The subcarrierSpacing identifies subcarrier spacing to be used in this BWP for all channels and reference signals unless explicitly configured elsewhere.

The BWP IE can also include uplink (UL) fields under BWP-Uplink. These include BWP-Id, BWP-Common and bwp-Dedicated.

The bwp-Id is an identifier for this bandwidth part. The RRC configuration can use the bwp-Id to associate with a particular bandwidth part. The BWP ID=0 is associated with the initial BWP. The network (NW) may trigger the UE to switch UL or DL BWP using a DCI field. The four code points in that DCI field can map to the RRC-configured BWP-ID as follows: For up to 3 configured BWPs (in addition to the initial BWP) the DCI code point is equivalent to the BWP ID (initial=0, first dedicated=1, . . . ). If the NW configures 4 dedicated bandwidth parts, they are identified by DCI code points 0 to 3. In this case it is not possible to switch to the initial BWP using the DCI field.

The IE 700 includes fields under BWP-UplinkCommon as pucch-ConfigCommon, pusch-ConfigCommon, rach-ConfigCommon and generic parameters. The pucch-ConfigCommon includes cell specific parameters for the PUCCH. The pusch-ConficCommon includes cell specific parameters for the PUCCH. The rach-ConfigCommon includes configuration of cell specific random access parameters which the UE uses for contention based and contention free random access as well as for contention based beam failure recovery. The NW configures SSB-based RA (and hence RACH-ConfigCommon) only for UL BWPs if the linked DL BWPs allows the UE to acquire the SSB associated to the serving cell.

The IE 700 includes BWP-UplinkDedicated, which includes fields as pucch-Config, pusch-Config, configuredGrantConfig, srs-Config, and beamFailureRecoverConfig. The pucch-Config is a PUCCH configuration for one BWP of the regular UL or SUL of a serving cell. If the UE is configured with SUL, the network configures PUCCH only on the BWPs of one of the uplinks (UL or SUL). The network configures PUCCH-Config for each SpCell. If supported by the UE, the network may configure at most one additional SCell of a cell group with PUCCH-Config (i.e. PUCCH SCell). The pusch-Config is a PUSCH configuration for one BWP of the regular UL or SUL of a serving cell. If the UE is configured with SUL and if it has a PUSCH-Config for both UL and SUL, a carrier indicator field in DCI indicates for which of the two to use an UL grant. The srs-Config is for an uplink sounding reference signal configuration. The beamFailureRecoverConfig determines how the UE performs beam failure recovery. The configuredGrantConfig is a configured grant of type 1 or type 2.

The IE 700 includes BWP-Downlink fields as bwp-id. As described above, the bwp-Id is an identifier for this bandwidth part.

The IE 700 can also include BWP-DownlinkCommon fields including pdcch-ConfigCommon, pdsch-ConfigCommon and genericParameters. The pdcch-ConfigCommon includes cell specific parameters for the PDCCH of this BWP. The pdsch-ConfigCommon includes cell specific parameters for the PDSCH of this BWP.

The IE 700 can also include BWP-DownlinkDedicated fields including pdcch-Config, pdsch-Config, radioLinkMonitoringConfig and sps-Config. The pdcch-Config includes UE specific PDCCH configuration for one BWP. The pdsch-Config includes UE specific PDSCH configuration for one BWP. The sps-Config includes UE specific SPS (semi-persistent scheduling) configuration for one BWP.

The radioLinkMonitoringConfig includes UE specific configuration of radio link monitoring for detecting cell- and beam radio link failure occasions.

The BWP configuration or IE 700 shown above is provided for illustrative purposes. It is appreciated that suitable variations and the like are contemplated.

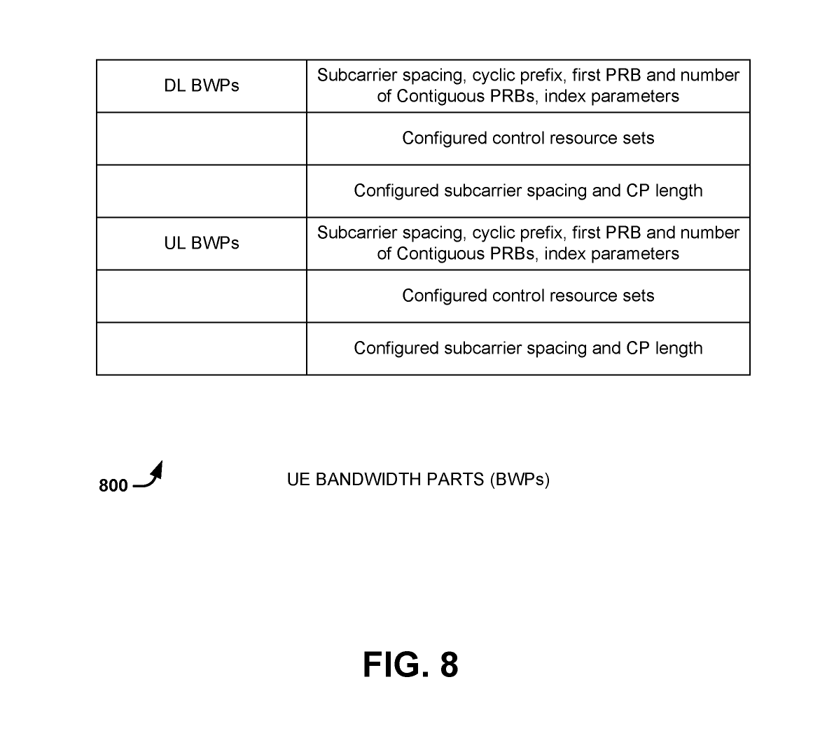

FIG. 8 is a diagram illustrating BWP configuration 800 for a set of BWPs in accordance with some embodiments. The configuration 800 can be used for/with the UE 401 and with the system 400, described above.

In this configuration 800, the UE has a set of BWPs that include a UL BWPs and DL BWPs. The UE described in FIG. 8 can be used as the UE 401 of the system 400.

The configuration 800 is provided as an example for illustrative purposes. It is appreciated that other configurations and operations are contemplated.

The configuration 800 illustrates fields, parameters, resources and the like for DL BWPs and UL BWPs.

For operation on a primary cell or on a secondary cell the UE is provided an initial active UL BWP by a higher layer parameter initialuplinkBWP. If the UE is configured with a supplementary carrier, the UE 401 can be provided an initial UL BWP on the supplementary carrier by a higher layer parameter initialUplinkBWP.

If the UE has a dedicated BWP configuration, the UE can be provided by higher layer parameter firstActiveDownlinkBWP-ID a first active DL BWP for reception and by higher layer parameter firstActiveUplinkBWP-ID a first active UL BWP for transmissions on the primary cell.

For each DL BWP or UL BWP, the UE can be configured with parameters/fields including subcarrier spacing, cyclic prefix, a first physical resource block (PRB) and a number of contiguous PRBs indicated by a location and bandwidth, an index to the set of DL BWPs and/or UL BWPs and the like.

The UE can also be configured for control resource sets for DL BWPs and UL BWPs on a primary cell.

For unpaired spectrum operation, a DL BWP from the set of configured DL BWPs with index provided by higher layer parameter bwp-Id for the DL BWP is linked with an UL BWP from the set of configured UL BWPs with index provided by higher layer parameter bwp-Id for the UL BWP when the DL BWP index and the UL BWP index are equal. For unpaired spectrum operation, the UE does not receive a configuration where the center frequency for a DL BWP is different than the center frequency for an UL BWP when the bwp-Id of the DL BWP is equal to the bwp-Id of the UL BWP.

For each DL BWP in a set of DL BWPs on the primary cell, the UE can have configured control resource sets for common search space and for UE-specific search space.

For each UL BWP in a set of UL BWPs, the UE is configured resource sets for PUCCH transmissions.

The UE receives PDCCH and PDSCH in a DL BWP according to a configured subcarrier spacing and CP length for the DL BWP. The UE transmits PUCCH and PUSCH in an UL BWP according to a configured subcarrier spacing and CP length for the UL BWP.

If a bandwidth part indicator field is configured in DCI format 1_1, the bandwidth part indicator field value indicates the active DL BWP, from the configured DL BWP set, for DL receptions. If a bandwidth part indicator field is configured in DCI format 0_1, the bandwidth part indicator field value indicates the active UL BWP, from the configured UL BWP set, for UL transmissions. If a bandwidth part indicator field is configured in DCI format 0_1 or DCI format 1_1 and indicates an UL BWP or a DL BWP different from the active UL BWP or DL BWP, respectively, the UE can prepend zeros to the information field until its size is the one required for the interpretation of the information field for the UL BWP or DL BWP prior to interpreting the DCI format 0_1 or DCI format 1_1 information fields, respectively.

The UE can detect a DCI format 0_1 indicating active UL BWP change, or a DCI format 1_1 indicating active DL BWP change, if a corresponding PDCCH is received within the first 3 symbols of a slot.

For the primary cell, the UE can be provided by higher layer parameter defaultDownlinkBWP-Id a default DL BWP among the configured DL BWPs. If the UE is not provided a default DL BWP by higher layer parameter defaultDownlinkBWP-Id, the default DL BWP is the initial active DL BWP.

If the UE is configured for a secondary cell with higher layer parameter defaultDownlinkBWP-Id indicating a default DL BWP among the configured DL BWPs and the UE is configured with higher layer parameter bwp-InactivityTimer indicating a timer value, the UE procedures on the secondary cell are same as on the primary cell using the timer value for the secondary cell and the default DL BWP for the secondary cell.

If the UE is configured by higher layer parameter bwp-InactivityTimer, a timer value for the primary cell, and the timer is running, the UE increments the timer every interval of 1 millisecond for frequency range 1 or every 0.5 milliseconds for frequency range 2 if the UE does not detect a DCI format for PDSCH reception on the primary cell for paired spectrum operation or if the UE does not detect a DCI format for PDSCH reception or a DCI format for PUSCH transmission on the primary cell for unpaired spectrum operation during the interval.

If the UE is configured by higher layer parameter BWP-InactivityTimer, a timer value for a secondary cell, and the timer is running, the UE increments the timer every interval of 1 millisecond for frequency range 1 or every 0.5 milliseconds for frequency range 2 if the UE does not detect a DCI format for PDSCH reception on the secondary cell for paired spectrum operation or if the UE does not detect a DCI format for PDSCH reception or a DCI format for PUSCH transmission on the secondary cell for unpaired spectrum operation during the interval. The UE may deactivate the secondary cell when the timer expires.

If the UE is configured by higher layer parameter firstActiveDownlinkBWP-Id, a first active DL BWP and by higher layer parameter firstActiveUplinkBWP-Id a first active UL BWP on a secondary cell or supplementary carrier, the UE uses the indicated DL BWP and the indicated UL BWP on the secondary cell as the respective first active DL BWP and first active UL BWP on the secondary cell or supplementary carrier.

For paired spectrum operation, the UE does not transmit HARQ-ACK information on a PUCCH resource indicated by a DCI format 1_0 or a DCI format 1_1 if the UE changes its active UL BWP on the PCell between a time of a detection of the DCI format 1_0 or the DCI format 1_1 and a time of a corresponding HARQ-ACK information transmission on the PUCCH.

The UE does or can monitor PDCCH when the UE performs RRM measurements over a bandwidth that is not within the active DL BWP for the UE.

It is appreciated that the above description for FIG. 8 is provided as an example for illustrative purposes.

As used herein, the term “circuitry” may refer to, be part of, or include an Application Specific Integrated Circuit (ASIC), an electronic circuit, a processor (shared, dedicated, or group), and/or memory (shared, dedicated, or group) that execute one or more software or firmware programs, a combinational logic circuit, and/or other suitable hardware components that provide the described functionality. In some embodiments, the circuitry may be implemented in, or functions associated with the circuitry may be implemented by, one or more software or firmware modules. In some embodiments, circuitry may include logic, at least partially operable in hardware.

As it employed in the subject specification, the term “processor” can refer to substantially any computing processing unit or device including, but not limited to including, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit, a digital signal processor, a field programmable gate array, a programmable logic controller, a complex programmable logic device, a discrete gate or transistor logic, discrete hardware components, or any combination thereof designed to perform the functions and/or processes described herein. Processors can exploit nano-scale architectures such as, but not limited to, molecular and quantum-dot based transistors, switches and gates, in order to optimize space usage or enhance performance of mobile devices. A processor may also be implemented as a combination of computing processing units.

In the subject specification, terms such as “store,” “data store,” data storage,” “database,” and substantially any other information storage component relevant to operation and functionality of a component and/or process, refer to “memory components,” or entities embodied in a “memory,” or components including the memory. It is noted that the memory components described herein can be either volatile memory or nonvolatile memory, or can include both volatile and nonvolatile memory.

By way of illustration, and not limitation, nonvolatile memory, for example, can be included in a memory, non-volatile memory (see below), disk storage (see below), and memory storage (see below). Further, nonvolatile memory can be included in read only memory, programmable read only memory, electrically programmable read only memory, electrically erasable programmable read only memory, or flash memory. Volatile memory can include random access memory, which acts as external cache memory.

Examples can include subject matter such as a method, means for performing acts or blocks of the method, at least one machine-readable medium including instructions that, when performed by a machine cause the machine to perform acts of the method or of an apparatus or system for concurrent communication using multiple communication technologies according to embodiments and examples described herein.

Example 1 is an apparatus configured to be employed within a base station, such as a next Generation NodeB (gNB). The apparatus comprises baseband circuitry and/or application circuitry which includes a radio frequency (RF) interface and one or more processors. The one or more processors are configured to generate a bandwidth part (BWP) configuration for a user equipment (UE) device, where the BWP configuration includes an initial BWP for the UE device; and provide the BWP configuration to the UE device using the RF interface.

Example 2 includes the subject matter of Example 1, including or omitting optional elements, wherein the one or more processors are configured to wherein the one or more processors are configured to generate a system information block (SIB) including the BWP configuration that includes the initial BWP for the UE device and provide the SIB to the RF interface for transmission to the UE device.

Example 3 includes the subject matter of any of Examples 1-2, including or omitting optional elements, wherein the gNB is of a serving cell and the one or more processors are configured to generate a list of initial BWPs of a neighboring cell and provide the generated list to the UE via the RF interface.

Example 4 includes the subject matter of any of Examples 1-3, including or omitting optional elements, wherein the one or more processors are configured to generate radio resource control (RRC) layer signals for the BWP configuration and to signal the RRC layer signals to the UE device.

Example 5 includes the subject matter of any of Examples 1-4, including or omitting optional elements, wherein the BWP configuration includes downlink and uplink BWP configurations for one or more downlink BWPs and one or more uplink BWPs.

Example 6 includes the subject matter of any of Examples 1-5, including or omitting optional elements, wherein the gNB is an active serving cell if at least one BWP for the gNB and the UE device is active.

Example 7 includes the subject matter of any of Examples 1-6, including or omitting optional elements, wherein the one or more processors are configured to generate a radio resource control (RRC) signals for the BWP configuration for one or more BWPs associated with the UE device and the gNB.

Example 8 includes the subject matter of any of Examples 1-7, including or omitting optional elements, wherein the RRC signals indicate a procedure to add and/or release a BWP from or to the one or more BWPs.

Example 9 includes the subject matter of any of Examples 1-8, including or omitting optional elements, wherein the RRC signals includes activation or deactivation of a BWP of the one or more BWPs.

Example 10 includes the subject matter of any of Examples 1-9, including or omitting optional elements, wherein the activation is timer based.

Example 11 includes the subject matter of any of Examples 1-10, including or omitting optional elements, wherein the one or more processors are configured to generate downlink control information (DCI) having an activation and/or deactivation procedure for one or more BWPs.

Example 12 includes the subject matter of any of Examples 1-11, including or omitting optional elements, wherein the one or more processors are configured to generate a radio resource management (RRM) measurement configuration and provide the RRM measurement configuration to the RF interface for transmission to the UE device.

Example 13 includes the subject matter of any of Examples 1-12, including or omitting optional elements, wherein the one or more processors are configured to receive RRM measurement based on the RRM measurement configuration for a BWP from the UE device using the RF interface.

Example 14 includes the subject matter of any of Examples 1-13, including or omitting optional elements, wherein a synchronization signal (SS) block is in the initial BWP and the SS block is used by the UE device to generate a RRM measurement.

Example 15 includes the subject matter of any of Examples 1-14, including or omitting optional elements, wherein a synchronization signal (SS) block is in an active BWP for the UE device and the location of the SS block is provided in the RRM measurement configuration.

Example 16 includes the subject matter of any of Examples 1-15, including or omitting optional elements, wherein the RRM measurement configuration identifies one BWP of a plurality of configured BWPs for the UE device as having a synchronization signal (SS) block.

Example 17 is an apparatus for a user equipment (UE) device, comprising baseband circuitry having a radio frequency (RF) interface and one or more processors. radio frequency (RF) interface is configured to receive a radio resource management (RRM) measurement configuration. The one or more processors are configured to identify a synchronization signal (SS) block of a bandwidth part (BWP) using the RRM measurement configuration; measure a cell using the RRM measurement configuration to obtain a radio resource management (RRM) measurement; and provide the RRM measurement to the RF interface.

Example 18 includes the subject matter of Example 17, including or omitting optional elements, wherein the RRM measurement is for a serving cell.

Example 19 includes the subject matter of any of Examples 17-18, including or omitting optional elements, wherein the RRM measurement is for a neighboring cell.

Example 20 includes the subject matter of any of Examples 17-19, including or omitting optional elements, wherein the one or more processors are configured to measure the cell using an RRM gap from the RRM measurement configuration.

Example 21 includes the subject matter of any of Examples 17-20, including or omitting optional elements, wherein the synchronization signal (SS) block is in an active BWP.

Example 22 includes the subject matter of any of Examples 17-21, including or omitting optional elements, wherein the synchronization signal (SS) block is not located on an active BWP and communications from a next Generation NodeB (gNB) for the cell are suspended for a duration to obtain the RRM measurement.

Example 23 includes the subject matter of any of Examples 17-22, including or omitting optional elements, wherein the RRM measurement configuration specifies a periodicity for the cell measurement.

Example 24 includes the subject matter of any of Examples 17-23, including or omitting optional elements, wherein the cell is a neighboring cell.

Example 25 includes the subject matter of any of Examples 17-24, including or omitting optional elements, wherein the one or more processors are configured to transition to the BWP based on a radio resource control (RRC) mode, wherein the RRC mode is one of connected with data, connected without data and idle.

Example 26 includes the subject matter of any of Examples 17-25, including or omitting optional elements, wherein the RRM configuration indicates whether a RRM gap is used based on the cell and the BWP.

Example 27 includes the subject matter of any of Examples 17-26, including or omitting optional elements, wherein the SS block for the cell and one or more SS blocks for one or more additional cells are located on the same center frequency and the one or more processors are configured to measure the cell and the one or more additional cells using the same center frequency.

Example 28 includes the subject matter of any of Examples 17-27, including or omitting optional elements, wherein the one or more processors are configured to receive a measurement gap from a network.

Example 29 is one or more computer-readable media having instructions that, when executed, cause a base station to generate a bandwidth part (BWP) configuration for a set of BWPs for a user equipment (UE) device; transmit the BWP configuration to the UE device; generate a measurement configuration for a BWP of the set of BWPs using the BWP configuration; and receive a radio resource management (RRM) measurement from the UE device based on the generated measurement configuration.

Example 30 includes the subject matter of Example 29, including or omitting optional elements, wherein the instructions, when executed, cause the base station to reconfigure the one or more BWPs based on the received measurement.

Example 31 includes the subject matter of any of Examples 29-30, including or omitting optional elements, wherein the measurement configuration identifies a synchronization signal (SS) block for the BWP.

Example 32 is an apparatus configured to be employed within a base station, such as a next Generation NodeB (gNB). The apparatus comprises baseband circuitry and application circuitry which includes a radio frequency (RF) interface and one or more processors. The one or more processors are configured to generate a measurement configuration; provide the measurement configuration to a user equipment (UE) device using the RF interface; and receive a radio resource management (RRM) measurement based on the measurement configuration for a BWP from the UE device using the RF interface.

Example 33 includes the subject matter of Example 32, including or omitting optional elements, wherein the one or more processors are configured to generate radio resource control (RRC) signals for the measurement configuration and transmit the RRC signals to the UE device using the RF interface.

As used herein, the term “circuitry” may refer to, be part of, or include an Application Specific Integrated Circuit (ASIC), an electronic circuit, a processor (shared, dedicated, or group), and/or memory (shared, dedicated, or group) that execute one or more software or firmware programs, a combinational logic circuit, and/or other suitable hardware components that provide the described functionality. In some embodiments, the circuitry may be implemented in, or functions associated with the circuitry may be implemented by, one or more software or firmware modules. In some embodiments, circuitry may include logic, at least partially operable in hardware.

As it employed in the subject specification, the term “processor” can refer to substantially any computing processing unit or device including, but not limited to including, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit, a digital signal processor, a field programmable gate array, a programmable logic controller, a complex programmable logic device, a discrete gate or transistor logic, discrete hardware components, or any combination thereof designed to perform the functions and/or processes described herein. Processors can exploit nano-scale architectures such as, but not limited to, molecular and quantum-dot based transistors, switches and gates, in order to optimize space usage or enhance performance of mobile devices. A processor may also be implemented as a combination of computing processing units.

In the subject specification, terms such as “store,” “data store,” data storage,” “database,” and substantially any other information storage component relevant to operation and functionality of a component and/or process, refer to “memory components,” or entities embodied in a “memory,” or components including the memory. It is noted that the memory components described herein can be either volatile memory or nonvolatile memory, or can include both volatile and nonvolatile memory.

It is to be understood that aspects described herein can be implemented by hardware, software, firmware, or any combination thereof. When implemented in software, functions can be stored on or transmitted over as one or more instructions or code on a computer-readable medium. Computer-readable media includes both computer storage media and communication media including any medium that facilitates transfer of a computer program from one place to another. A storage media or a computer readable storage device can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or other tangible and/or non-transitory medium, that can be used to carry or store desired information or executable instructions. Also, any connection is properly termed a computer-readable medium. For example, if software is transmitted from a website, server, or other remote source using a coaxial cable, fiber optic cable, twisted pair, digital subscriber line (DSL), or wireless technologies such as infrared, radio, and microwave, then coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

Various illustrative logics, logical blocks, modules, and circuits described in connection with aspects disclosed herein can be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform functions described herein. A general-purpose processor can be a microprocessor, but, in the alternative, processor can be any conventional processor, controller, microcontroller, or state machine. A processor can also be implemented as a combination of computing devices, for example, a combination of a DSP and a microprocessor, a plurality of microprocessors, one or more microprocessors in conjunction with a DSP core, or any other such configuration. Additionally, at least one processor can comprise one or more modules operable to perform one or more of the s and/or actions described herein.

For a software implementation, techniques described herein can be implemented with modules (e.g., procedures, functions, and so on) that perform functions described herein. Software codes can be stored in memory units and executed by processors. Memory unit can be implemented within processor or external to processor, in which case memory unit can be communicatively coupled to processor through various means as is known in the art. Further, at least one processor can include one or more modules operable to perform functions described herein.

Techniques described herein can be used for various wireless communication systems such as CDMA, TDMA, FDMA, OFDMA, SC-FDMA and other systems. The terms “system” and “network” are often used interchangeably. A CDMA system can implement a radio technology such as Universal Terrestrial Radio Access (UTRA), CDMA1800, etc. UTRA includes Wideband-CDMA (W-CDMA) and other variants of CDMA. Further, CDMA1800 covers IS-1800, IS-95 and IS-856 standards. A TDMA system can implement a radio technology such as Global System for Mobile Communications (GSM). An OFDMA system can implement a radio technology such as Evolved UTRA (E-UTRA), Ultra Mobile Broadband (UMB), IEEE 802.11 (Wi-Fi), IEEE 802.16 (WiMAX), IEEE 802.18, Flash-OFDM, etc. UTRA and E-UTRA are part of Universal Mobile Telecommunication System (UMTS). 3GPP Long Term Evolution (LTE) is a release of UMTS that uses E-UTRA, which employs OFDMA on downlink and SC-FDMA on uplink. UTRA, E-UTRA, UMTS, LTE and GSM are described in documents from an organization named “3rd Generation Partnership Project” (3GPP). Additionally, CDMA1800 and UMB are described in documents from an organization named “3rd Generation Partnership Project 2” (3GPP2). Further, such wireless communication systems can additionally include peer-to-peer (e.g., mobile-to-mobile) ad hoc network systems often using unpaired unlicensed spectrums, 802.xx wireless LAN, BLUETOOTH and any other short- or long- range, wireless communication techniques.

Single carrier frequency division multiple access (SC-FDMA), which utilizes single carrier modulation and frequency domain equalization is a technique that can be utilized with the disclosed aspects. SC-FDMA has similar performance and essentially a similar overall complexity as those of OFDMA system. SC-FDMA signal has lower peak-to-average power ratio (PAPR) because of its inherent single carrier structure. SC-FDMA can be utilized in uplink communications where lower PAPR can benefit a mobile terminal in terms of transmit power efficiency.

Moreover, various aspects or features described herein can be implemented as a method, apparatus, or article of manufacture using standard programming and/or engineering techniques. The term “article of manufacture” as used herein is intended to encompass a computer program accessible from any computer-readable device, carrier, or media. For example, computer-readable media can include but are not limited to magnetic storage devices (e.g., hard disk, floppy disk, magnetic strips, etc.), optical disks (e.g., compact disk (CD), digital versatile disk (DVD), etc.), smart cards, and flash memory devices (e.g., EPROM, card, stick, key drive, etc.). Additionally, various storage media described herein can represent one or more devices and/or other machine-readable media for storing information. The term “machine-readable medium” can include, without being limited to, wireless channels and various other media capable of storing, containing, and/or carrying instruction(s) and/or data. Additionally, a computer program product can include a computer readable medium having one or more instructions or codes operable to cause a computer to perform functions described herein.

Communications media embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

Further, the actions of a method or algorithm described in connection with aspects disclosed herein can be embodied directly in hardware, in a software module executed by a processor, or a combination thereof. A software module can reside in RAM memory, flash memory, ROM memory, EPROM memory, EEPROM memory, registers, a hard disk, a removable disk, a CD-ROM, or any other form of storage medium known in the art. An exemplary storage medium can be coupled to processor, such that processor can read information from, and write information to, storage medium. In the alternative, storage medium can be integral to processor. Further, in some aspects, processor and storage medium can reside in an ASIC. Additionally, ASIC can reside in a user terminal. In the alternative, processor and storage medium can reside as discrete components in a user terminal. Additionally, in some aspects, the s and/or actions of a method or algorithm can reside as one or any combination or set of codes and/or instructions on a machine-readable medium and/or computer readable medium, which can be incorporated into a computer program product.

The above description of illustrated embodiments of the subject disclosure, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the disclosed subject matter has been described in connection with various embodiments and corresponding Figures, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

In particular regard to the various functions performed by the above described components (assemblies, devices, circuits, systems, etc.), the terms (including a reference to a “means”) used to describe such components are intended to correspond, unless otherwise indicated, to any component or structure which performs the specified function of the described component (e.g., that is functionally equivalent), even though not structurally equivalent to the disclosed structure which performs the function in the herein illustrated exemplary implementations of the disclosure. In addition, while a particular feature may have been disclosed with respect to only one of several implementations, such feature may be combined with one or more other features of the other implementations as may be desired and advantageous for any given or particular application.

What is claimed is:

1. An apparatus for a next Generation NodeB (gNB), comprising baseband circuitry having:
a radio frequency (RF) interface; and
one or more processors configured to:
generate a bandwidth part (BWP) configuration for a user equipment (UE) device, where the BWP configuration includes an initial BWP for the UE device; and
provide the BWP configuration to the UE device using the RF interface.

2. The apparatus of claim 1, wherein the one or more processors are configured to generate a system information block (SIB) including the BWP configuration that includes the initial BWP for the UE device and provide the SIB to the RF interface for transmission to the UE device.

3. The apparatus of claim 1, wherein the gNB is of a serving cell and the one or more processors are configured to generate a list of initial BWPs of a neighboring cell and provide the generated list to the UE via the RF interface.

4. The apparatus of claim 1, wherein the one or more processors are configured to generate radio resource control (RRC) layer signals for the BWP configuration and to signal the RRC layer signals to the UE device.

5. The apparatus of claim 4, wherein the BWP configuration includes downlink and uplink BWP configurations for one or more downlink BWPs and one or more uplink BWPs.

6. The apparatus of claim 1, wherein the gNB is an active serving cell if at least one BWP for the gNB and the UE device is active.

7. The apparatus of claim 1, wherein the one or more processors are configured to generate a radio resource control (RRC) signals for the BWP configuration for one or more BWPs associated with the UE device and the gNB.

8. The apparatus of claim 7, wherein the RRC signals indicate a procedure to add and/or release a BWP from or to the one or more BWPs.

9. The apparatus of claim 7, wherein the RRC signals includes activation or deactivation of a BWP of the one or more BWPs.

10. The apparatus of claim 9, wherein the activation is timer based.

11. The apparatus of claim 1, wherein the one or more processors are configured to generate downlink control information (DCI) having an activation and/or deactivation procedure for one or more BWPs.

12. The apparatus of claim 1, wherein the one or more processors are configured to generate a radio resource management (RRM) measurement configuration and provide the RRM measurement configuration to the RF interface for transmission to the UE device.

13. The apparatus of claim 12, wherein the one or more processors are configured to receive RRM measurement based on the RRM measurement configuration for a BWP from the UE device using the RF interface.

14. The apparatus of claim 12, wherein a synchronization signal (SS) block is in the initial BWP and the SS block is used by the UE device to generate a RRM measurement.

15. The apparatus of claim 12, wherein a synchronization signal (SS) block is in an active BWP for the UE device and the location of the SS block is provided in the RRM measurement configuration.

16. The apparatus of claim 12, wherein the RRM measurement configuration identifies one BWP of a plurality of configured BWPs for the UE device as having a synchronization signal (SS) block.

17. An apparatus for a user equipment (UE) device, comprising baseband circuitry having:
a radio frequency (RF) interface configured to receive a radio resource management (RRM) measurement configuration;
one or more processors configured to:
identify a synchronization signal (SS) block of a bandwidth part (BWP) using the RRM measurement configuration;
measure a cell using the RRM measurement configuration to obtain a radio resource management (RRM) measurement; and
provide the RRM measurement to the RF interface.

18. The apparatus of claim 17, wherein the RRM measurement is for a serving cell.

19. The apparatus of claim 17, wherein the RRM measurement is for a neighboring cell.

20. The apparatus of claim 17, wherein the one or more processors are configured to measure the cell using an RRM gap from the RRM measurement configuration.

21. The apparatus of claim 17, wherein the synchronization signal (SS) block is in an active BWP.

22. The apparatus of claim 17, wherein the synchronization signal (SS) block is not located on an active BWP and communications from a next Generation NodeB (gNB) for the cell are suspended for a duration to obtain the RRM measurement.

23. The apparatus of claim 17, wherein the RRM measurement configuration specifies a periodicity for the cell measurement.

24. The apparatus of claim 17, wherein the cell is a neighboring cell.

25. The apparatus of claim 17, wherein the one or more processors are configured to transition to the BWP based on a radio resource control (RRC) mode, wherein the RRC mode is one of connected with data, connected without data and idle.

26. The apparatus of claim 17, wherein the RRM configuration indicates whether a RRM gap is used based on the cell and the BWP.

27. The apparatus of claim 17, wherein the SS block for the cell and one or more SS blocks for one or more additional cells are located on the same center frequency and the one or more processors are configured to measure the cell and the one or more additional cells using the same center frequency.

28. The apparatus of claim 17, wherein the one or more processors are configured to receive a measurement gap from a network.

29. One or more computer-readable media having instructions that, when executed, cause a base station to:
generate a bandwidth part (BWP) configuration for a set of BWPs for a user equipment (UE) device;
transmit the BWP configuration to the UE device;
generate a measurement configuration for a BWP of the set of BWPs using the BWP configuration; and
receive a radio resource management (RRM) measurement from the UE device based on the generated measurement configuration.

30. The computer-readable media of claim 29, wherein the instructions, when executed, cause the base station to reconfigure the one or more BWPs based on the received measurement.

31. The computer-readable media of claim 29, wherein the measurement configuration identifies a synchronization signal (SS) block for the BWP.
